(19) United States
(12) Patent Application Publication
(10) Pub. No.: US 2007/0013978 A1
(43) Pub. Date: Jan. 18, 2007

(54) Color information measuring device, print object information measuring device, printing device and electrronic equipment

(75) Inventors: Nobuhisa Watanabe, Kashiba-shi (JP); Takayuki Taminaga, Nara-ken (JP); Hideo Wada, Katsuragi-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/482,748

(22) Filed: Jul. 10, 2006

(30) Foreign Application Priority Data
Jul. 13, 2005 (JP) P2005-204317
Nov. 24, 2005 (JP) P2005-338717

(51) Int. Cl. H04N 1/46

(52) U.S. Cl. 358/504; 358/1.9

(57) ABSTRACT

In the color information measuring device, the print object information measuring device, the printing device and the electronic equipment, three light fluxes of mutually different wavelengths applied to a measurement object from a red LED, a green LED and a blue LED of a light-emitting part have a common illumination area on the measurement object. The common illumination area on the measurement object contains such an observation area on the measurement object that a reflected ray is made to be incident on a photodiode via a condenser lens and a slit member. Therefore, the common illumination area in which three light fluxes of different wavelengths overlap with one another can reliably be made to be an observation area, so that intensities of a plurality of reflected rays of different wavelengths derived from the observation area can be observed equivalently, hence an improved measurement accuracy.

### CROSS-REFERENCE TO RELATED APPLICATIONS

This Nonprovisional application claims priority under 35 U.S.C. §119(a) on Patent Application No. 2005-204317 filed in Japan on Jul. 13, 2005, and No. 2005-338717 filed in Japan on Nov. 24, 2005, the entire contents of which are hereby incorporated by reference.

### BACKGROUND OF THE INVENTION

The present invention relates to color information measuring devices, for example, a color information measuring device for applying a plurality of light fluxes of different wavelengths from a light-emitting part to a measurement object, which is an object of measurement, and measuring intensities of reflected rays of the individual wavelengths derived from the measurement object to digitize color information on the measurement object and then output the color information to a color printer, color copier or other printing devices or a liquid crystal display or other image display units.

Also, the invention relates to electronic equipment including such a color information measuring device as shown above.

Also, the invention relates to a print object information measuring device for outputting color information and positional information on a print object, which is an object of printing, to, for example, a control section of a color printer or color copier.

Furthermore, the invention relates to a printing device using the print object information measuring device.

In recent years, a variety of printing devices such as ink jet printers have been widely used as output devices for computers. In such color printers as ink jet printers, color images are printed with four color inks composed of three color inks of cyan (C), magenta (M) and yellow (Y), plus black (K). Otherwise, color images are printed with six color inks composed of the four colors plus light cyan (lc) and light magenta (lm).

However, due to changes in temperature, humidity or other environmental conditions in which the printer is located, slight differences in characteristics of ink or sheet used for printing, or the like, it can occur that the density or color tone of printed images or the density or the like of printed images varies depending on the printer. Such changes or differences in characteristics occur due to changes with time of component elements constituting the printer.

Thus, it is desired to fulfill adjustment of density or chromaticity by installing a color sensor close to the output section of a printer, monitoring the printing state of a print object by the color sensor and by feeding back an output of the color sensor to the printer.

Such a color sensor is, for example, a color sensor 110 as shown in FIG. 21A (see JP 2003-107830 A). In this color sensor 110, a light flux applied from a white light source 111 is reflected by a measurement object 112, being incident on a light-receiving element 113. As shown in FIG. 21B, the light-receiving element 113 includes independent pixels 114, 115, 116 of red, green and blue, respectively, and each of the pixels 114, 115, 116 has a photoelectric conversion element.

The pixels 114, 115, 116 has wavelength filters which transmit wavelengths of red, green and blue, respectively. Measuring light intensities of red, green and blue, respectively, in these pixels 114, 115, 116, color information on the measurement object 112 can be digitized. Feeding back an output obtained by digitizing the color information to an unshown printer allows the printing state of the printer to be corrected.

However, the wavelength filters included in the color sensor are expensive, and moreover the resolution of the color sensor is insufficient.

Also, ink jet printers have been advanced toward higher quality of images with lower prices, and so used for private users to directly print photographs taken by digital cameras. For a private user to print a photograph or the like by an ink jet printer, there is a demand for frameless printing that allows more real texture to be obtained.

However, when the sheet is shifted from an assumed position, it can occur that the image is not formed at the assumed position on the sheet and moreover, in some cases, the image that should be formed at a proximity to an end portion of the sheet may overflow the sheet. In this case, ink drips may not land at end portions of the sheet on which they should land, but land on the printer casing, so that a sheet that passes through the same place thereafter may be contaminated. From this point of view also, it is of great importance to detect the position of the sheet.

One example of this sheet position detection device is a sheet position detection device 123 shown in FIG. 22 (see, e.g., JP 2002-103721 A). This sheet position detection device 123 is composed of a light-emitting diode 120 and a phototransistor 122. The light-emitting diode 120 emits light toward a specified detection point, and the phototransistor 122, upon receiving its reflected light, converts a change in light quantity into a change in electric current. Depending on whether the phototransistor 122 has received reflected light reflected by the sheet 121, it is decided whether or not an edge of the sheet 121 is present at the detection point.

As shown above, it has been the case that a device for measuring color information on the print object as well as a device for measuring positional information on the print object are necessitated as the device for measuring print object information, resulting in higher costs and larger sizes.

### SUMMARY OF THE INVENTION

Therefore, an object of the present invention is to provide a color information measuring device capable of enhancing the resolution while suppressing its cost.

Another object of the invention is to provide a electronic equipment including such a color information measuring device.

Still another object of the invention is to provide a print object information measuring device which is capable of measuring both color information and positional information on the print object at the same time and which is an integrated-type device of low price, small size and high accuracy.

Still further object of the invention is to provide a printing device including such a print object information measuring device.

In order to achieve the above object, there is provided a color information measuring device comprising:

a light-emitting part having a plurality of light-emitting elements which differ in emission wavelength from one another;

an illuminating part for illuminating an measurement object, which is to be measured, with a plurality of light fluxes of different wavelengths derived from the light-emitting part;

a light-receiving element for converting a plurality of received light fluxes of different wavelengths into electric signals, respectively, as their outputs; and

a condenser part for condensing reflected rays derived from the measurement object onto the light-receiving element, wherein

the plurality of light fluxes of mutually different wavelengths applied from the light-emitting elements to the measurement object have a common illumination area on the measurement object, and

the common illumination area on the measurement object contains an observation area on their measurement object from which reflected rays go incident on the light-receiving element via the condenser part.

According to the color information measuring device of this invention, the plurality of light-emitting elements of the light-emitting part generate a plurality of light fluxes of different wavelengths, and the illuminating part applies the plurality of light fluxes of different wavelengths, which are derived from the light-emitting part, to a measurement object. Then, the condenser part condenses reflected rays derived from the measurement object onto the light-receiving element, and the light-receiving element converts a plurality of received light fluxes of different wavelengths into electric signals, respectively, as its outputs. By the electric signals outputted by the light-receiving element, intensities of reflected rays of the individual wavelengths reflected by the measurement object can be measured. By this measurement of intensities of the reflected rays, color information on the measurement object can accurately be measured.

Further, in this invention, the plurality of light fluxes of mutually different wavelengths applied from the light-emitting elements to the measurement object have a common illumination area on the measurement object, and the common illumination area on the measurement object contains such an observation area on the measurement object that reflected rays are made to be incident on the light-receiving element via the condenser part. Therefore, the common illumination area in which the plurality of light fluxes of different wavelengths overlap with one another can reliably be made to be an observation area, so that intensities of the plurality of reflected rays of different wavelengths derived from the observation area can be observed equivalently, hence an improved measurement accuracy. Thus, according to this invention, a color information measuring device of high resolution and high accuracy can be realized without using any high-priced wavelength filter while cost increases are suppressed.

Also, in the color information measuring device according to one embodiment, the light-emitting part has three light-emitting elements which differ in emission wavelength from one another.

According to the color information measuring device of this embodiment, the light-emitting part generates three light fluxes of different wavelengths by three light-emitting elements, and makes those light fluxes applied to the measurement object via the illuminating part. Therefore, by selecting three wavelengths of the three light fluxes, measurement over the entire visible region becomes easily achievable and the measurement accuracy can be improved.

Also, in the color information measuring device according to one embodiment, the three light-emitting elements have emission wavelengths corresponding to red, green and blue, respectively.

According to the color information measuring device of this embodiment, since the emission wavelengths of the three light-emitting elements correspond to red, green and blue, respectively, measurement over the entire visible region becomes easily achievable and the measurement accuracy can be improved.

Also, the color information measuring device according to one embodiment further comprises a slit member placed between the condenser part and the light-receiving element, wherein

the slit member has a circular-shaped slit, and

the observation area on the measurement object is circular-shaped.

According to the color information measuring device of this embodiment, the slit member, having a circular-shaped slit, makes the observation area on the measurement object circular-shaped. By this circular-shaped observation area, effective light reception from the illumination area on the measurement object can be fulfilled with enough light quantity ensured, so that a high S/N ratio at the light-receiving element can be achieved.

Also, in the color information measuring device according to one embodiment, the observation area on the measurement object is smaller than a circle having a diameter of 2 mm.

According to the color information measuring device of this embodiment, since the observation area on the measurement object is made to be smaller than a circle having a diameter of 2 mm, a sufficient high measurement resolution can be achieved, contributing to the monitoring of the printing state of the printer as an example.

Also, in the color information measuring device according to one embodiment, the three light-emitting elements of the light-emitting part are formed on one board.

According to the color information measuring device of this embodiment, since the three light-emitting elements are formed on one board, a space saving can be achieved so that a more downsized color information measuring device can be realized.

Also, in the color information measuring device according to one embodiment, the three light-emitting elements of the light-emitting part include a light-emitting-element drive part for emitting light sequentially in time division.

According to the color information measuring device of this embodiment, since the light-emitting-element drive part makes the three light-emitting elements emit light sequentially in time division, three-color light fluxes are generated in time division, so that the emitted three colors are never mixed with one another. Thus, electric signals outputted in correspondence to the plurality of light fluxes of different wavelengths received by the light-receiving elements make it possible to fulfill high-accuracy color information measurement.

Also, in the color information measuring device according to one embodiment, the light-receiving element is a photodiode.

According to the color information measuring device of this embodiment, since the light-receiving element is a photodiode, low-priced, high-precision measurement can be achieved.

Also, the color information measuring device according to one embodiment further comprises:

a wavelength selector part placed between the condenser part and the light-receiving element, and

a light-emitting-element drive part for making the three light-emitting elements of the light-emitting part emit light simultaneously.

According to the color information measuring device of this embodiment, the wavelength selector part placed between the condenser part and the light-receiving element makes it possible to reduce light of unnecessary wavelengths out of the light traveling from the condenser part toward the light-receiving elements, so that measurement with a high S/N ratio can be achieved.

Also, in the color information measuring device according to one embodiment, the wavelength selector part is a diffraction grating.

According to the color information measuring device of this embodiment, by the use of a diffraction grating, a wavelength selector part which is lower-priced and smaller-sized than a wavelength filter can be realized.

Also, in the color information measuring device according to one embodiment, the light-receiving element is a divisional photodiode having a plurality of independent light-receiving portions.

According to the color information measuring device of this constitution, light fluxes of different wavelengths can be received individually and converted in signal form by a plurality of independent light-receiving portions of the divisional photodiode serving as the light-receiving elements. Thus, signal processing can be achieved simply.

Also, in the color information measuring device according to one embodiment, spot size of each of the light fluxes condensed at the light-receiving portions of the divisional photodiode by the condenser part is smaller than an area of its corresponding light-receiving portion.

According to the color information measuring device of this embodiment, light quantities of all the light fluxes condensed by the condenser part can be measured by the light-receiving portions, and moreover a light flux received by one light-receiving portion of the divisional photodiode never has influences on its adjacent light-receiving portions. Thus, measurement with a high S/N ratio can be achieved.

Also, in the color information measuring device according to one embodiment, the illuminating part is a lens.

According to the color information measuring device of this embodiment, since the illuminating part is a lens, a small-sized, low-priced color information measuring device can be realized.

Also, in the color information measuring device according to one embodiment, the condenser part is a lens.

According to the color information measuring device of this embodiment, since the condenser part is a lens, a small-sized, low-priced color information measuring device can be realized.

Also, in the color information measuring device according to one embodiment, one lens serves as both the illuminating part and the condenser part.

According to the color information measuring device of this embodiment, since one lens serves as both the illuminating part and the condenser part, a small-sized color information measuring device can be realized.

Also, in the color information measuring device according to one embodiment, the lens is a Fresnel lens.

According to the color information measuring device of this embodiment, since the lens is a Fresnel lens, a smaller-sized color information measuring device can be realized.

Also, the color information measuring device according to one embodiment further comprises a signal processing part for normalizing an electric signal outputted by the light-receiving element with a reference signal.

According to the color information measuring device of this embodiment, variations of output signals of the light-receiving elements that vary due to temperature or other ambient environments can be canceled out by the normalization by the reference signal.

Also, in the color information measuring device according to one embodiment, the signal processing part normalizes an electric signal outputted by the light-receiving element by using an upper-limit reference signal and a lower-limit reference signal.

According to the color information measuring device of this embodiment, the signal processing part makes it possible to digitize color information by electric signals outputted by the light-receiving elements with a fixed scale using the upper-limit reference signal and the lower-limit reference signal.

Also, in the color information measuring device according to one embodiment,

the upper-limit reference signal is an electric signal which is outputted by the light-receiving element upon reception of a reflected ray derived from a white portion, and

the lower-limit reference signal is an electric signal which is outputted by the light-receiving element upon reception of a reflected ray derived from a black portion.

According to the color information measuring device of this embodiment, the upper-limit reference signal is an electric signal which is outputted by the light-receiving element upon reception of a reflected ray derived from a white portion, and the lower-limit reference signal is an electric signal which is outputted by the light-receiving element upon reception of a reflected ray derived from a black portion. Therefore, reference signals can be fixed, making it possible to fulfill absolute digitization of color information by electric signals outputted by the light-receiving element.

Also, in the color information measuring device according to one embodiment, the light-emitting elements are light-emitting diodes.

According to the color information measuring device of this embodiment, since the light-emitting elements are light-emitting diodes, a low-priced color information measuring device can be realized.

Also, the color information measuring device according to one embodiment further comprises a pulse drive part for driving the light-emitting elements in pulses.

According to the color information measuring device of this embodiment, since the light-emitting elements are driven in pulses, the average current consumption in the light-emitting elements can be suppressed, so that the light-emitting elements are elongated in life, hence economical.

Also, in the color information measuring device according to one embodiment, the pulse drive part drives the light-emitting elements in pulses at a duty ratio of 0.1 or less.

According to the color information measuring device of this embodiment, by setting the duty ratio of drive pulses to 0.1 or less, the light quantity of light fluxes generated by the light-emitting elements can be increased to a necessary level while the average current consumption is suppressed.

Also, electronic equipment according to one embodiment includes any one of the color information measuring devices as described above. According to the electronic equipment of this embodiment, small-sized, high-performance electronic equipment is provided by virtue of the small-sized, high-performance color information measuring device.

Also, in the electronic equipment according to one embodiment, the electronic equipment is functionally controlled by electric signals outputted by the color information measuring device. According to the electronic equipment of this embodiment, high-accuracy functional control becomes implementable by virtue of the color information measuring device, so that small-sized, high-performance electronic equipment can be realized.

As described above, according to the color information measuring device of the invention, the plurality of light-emitting elements of the light-emitting part generate a plurality of light fluxes of different wavelengths, and the illuminating part applies the plurality of light fluxes of different wavelengths, which are derived from the light-emitting part, to a measurement object. Then, the condenser part condenses reflected rays derived from the measurement object onto the light-receiving element, and the light-receiving element converts a plurality of received light fluxes of different wavelengths into electric signals, respectively, as its outputs. By the electric signals outputted by the light-receiving element, intensities of reflected rays of the individual wavelengths reflected by the measurement object can be measured. By this measurement of intensities of the reflected rays, color information on the measurement object can accurately be measured.

Further, in this invention, the plurality of light fluxes of mutually different wavelengths applied from the light-emitting elements to the measurement object have a common illumination area on the measurement object, and the common illumination area on the measurement object contains such an observation area on the measurement object that reflected rays are made to be incident on the light-receiving element via the condenser part. Therefore, the common illumination area in which the plurality of light fluxes of different wavelengths overlap with one another can reliably be made to be an observation area, so that intensities of the plurality of reflected rays of different wavelengths derived from the observation area can be observed equivalently, hence an improved measurement accuracy. Thus, according to this invention, a color information measuring device of high resolution and high accuracy can be realized without using any high-priced wavelength filter while cost increases are suppressed.

Also, according to the present invention, there is provided a print object information measuring device comprising:

a light-emitting part for emitting a plurality of light fluxes which differ in emission wavelength from one another;

a light-emitting-part side condenser part for converting each light flux derived from the light-emitting part into collimated light of substantially parallel state;

an objective-side condenser part for applying the collimated light derived from the light-emitting-part side condenser part onto a print object and further converting a diffusely reflected ray and a regularly reflected ray derived from the print object into collimated light of substantially parallel state, respectively;

a diffusely-reflected-ray receiving part for converting the diffusely reflected ray derived from the print object into an electric signal;

a regularly-reflected-ray receiving part for converting the regularly reflected ray derived from the print object into an electric signal;

a diffusely-reflected-ray condenser part which is positioned between the objective-side condenser part and the diffusely-reflected-ray receiving part and which condenses the collimated light derived from the objective-side condenser part onto the diffusely-reflected-ray receiving part;

a regularly-reflected-ray condenser part which is positioned between the objective-side condenser part and the regularly-reflected-ray receiving part and which condenses the collimated light derived from the objective-side condenser part onto the regularly-reflected-ray receiving part; and

a calculation part for calculating color information on the print object by an output derived from at least either the diffusely-reflected-ray receiving part or the regularly-reflected-ray receiving part and moreover calculating positional information on the print object by an output derived from the regularly-reflected-ray receiving part.

It is noted here that the term “print object” refers, for example, to a sheet to be outputted from the printing device.

According to the print object information measuring device of this invention, a plurality of light fluxes of mutually different wavelengths are emitted from the light-emitting part, each light flux derived from the light-emitting part is converted into collimated light by the light-emitting-part side condenser part, and the print object is illuminated with the light via the objective-side condenser part.

Then, reflected rays from the print object are converted into collimated light by the objective-side condenser part, respectively, and condensed onto the diffusely-reflected-ray receiving part by the diffusely-reflected-ray condenser part or onto the regularly-reflected-ray receiving part by the regularly-reflected-ray condenser part.

The individual receiving parts convert a plurality of received light fluxes of mutually different wavelengths into electric signals proportional to received light intensities, respectively, as their outputs. That is, by the electric signals outputted by the individual receiving parts, intensities of the reflected rays of the individual wavelengths reflected by the print object can be measured.

Then, the calculation part can calculate color information on the print object by an output derived from at least either the diffusely-reflected-ray receiving part or the regularly-reflected-ray receiving part and moreover calculate positional information on the print object by an output derived from the regularly-reflected-ray receiving part.

Thus, the print object information measuring device applies a plurality of light fluxes of different wavelengths from the light-emitting part to the print object, and measures reflected-ray intensities of reflected rays of individual wavelengths of diffusely reflected rays and regularly reflected rays out of reflected rays derived from the print object to detect color information on the print object, and moreover measures reflected-ray intensities of individual wavelengths of regularly reflected rays out of reflected rays derived from the print object to detect positional information on the print object. Therefore, color information and positional information on the print object can be measured simultaneously, so that a low-priced, small-sized print object information measuring device can be realized.

Also, in the print object information measuring device of one embodiment, the light-emitting part has three light-emitting elements which differ in emission wavelength from one another.

According to the print object information measuring device of this embodiment, the light-emitting part makes the three light-emitting elements emit three light fluxes of different wavelengths so that the light fluxes are applied onto the print object via the light-emitting-part side condenser part and the objective-side condenser part. By selecting three wavelengths of the three light fluxes, measurement over the entire visible region becomes easily achievable and a low-priced, high-accuracy print object information measuring device can be provided.

Also, in the print object information measuring device of one embodiment, the three light-emitting elements have emission wavelengths corresponding to red, green and blue, respectively.

According to the print object information measuring device of this embodiment, since the three light-emitting elements have emission wavelengths corresponding to red, green and blue, respectively, measurement over the entire visible region becomes effectively achievable.

Also, the print object information measuring device of one embodiment further comprises:

a diffusely-reflected-ray slit portion placed between the diffusely-reflected-ray condenser part and the diffusely-reflected-ray receiving part and having a slit, wherein

the plurality of light fluxes applied from the light-emitting part onto the print object form a common illumination area on the print object, and

the illumination area contains such a diffusely-reflected-ray observation area that the diffusely reflected ray is made to be incident on the diffusely-reflected-ray receiving part via the objective-side condenser part, the diffusely-reflected-ray condenser part and the slit of the diffusely-reflected-ray slit portion.

According to the print object information measuring device of this embodiment, by properly designing the shape of the slit of the diffusely-reflected-ray slit portion, the diffusely-reflected-ray observation area can be set to a desired size, so that the spatial resolution of the print object information measuring device can be designed properly.

Also, in the print object information measuring device of one embodiment, the slit of the diffusely-reflected-ray slit portion is circular-shaped.

According to the print object information measuring device of this embodiment, since the slit of the diffusely-reflected-ray slit portion is circular-shaped, the diffusely-reflected-ray observation area on the print object can be made circular-shaped. By this circular-shaped diffusely-reflected-ray observation area, effective light reception from the illumination area on the print object can be fulfilled with enough light quantity ensured, so that a high S/N ratio at the diffusely-reflected-ray receiving part can be achieved.

Also, the print object information measuring device of one embodiment further comprises:

a regularly-reflected-ray slit portion placed between the regularly-reflected-ray condenser part and the regularly-reflected-ray receiving part and having a slit, wherein

the plurality of light fluxes applied from the light-emitting part to the print object have a common illumination area on the print object, and

the illumination area contains such a regularly-reflected-ray observation area that the regularly reflected ray is made to be incident on the regularly-reflected-ray receiving part via the objective-side condenser part, the regularly-reflected-ray condenser part and the slit of the regularly-reflected-ray slit portion.

According to the print object information measuring device of this embodiment, by properly designing the shape of the slit of the regularly-reflected-ray slit portion, the regularly-reflected-ray observation area can be set to a desired size, so that the spatial resolution of the print object information measuring device can be designed properly.

Also, in the print object information measuring device of one embodiment, the slit of the regularly-reflected-ray slit portion is rectangular-shaped.

According to the print object information measuring device of this embodiment, since the slit of the regularly-reflected-ray slit portion is rectangular-shaped, the regularly-reflected-ray observation area on the print object can be made rectangular-shaped. Also, in the case where the slit of the regularly-reflected-ray slit portion is formed into such a rectangular shape that the length of the regularly-reflected-ray observation area in the print-object conveyance direction is smaller while the length of the regularly-reflected-ray observation area in a direction perpendicular to the print-object conveyance direction is larger, the positional detection accuracy in the print-object conveyance direction can be improved and the light quantity is increased, making it possible to improve the S/N ratio.

Also, in the print object information measuring device of one embodiment, the light-emitting-part side condenser part is a lens.

According to the print object information measuring device of this embodiment, since the light-emitting-part side condenser part is a lens, a small-sized, low-priced print object information measuring device can be realized.

Also, in the print object information measuring device of one embodiment, the diffusely-reflected-ray condenser part is a lens.

According to the print object information measuring device of this embodiment, since the diffusely-reflected-ray condenser part is a lens, a small-sized, low-priced print object information measuring device can be realized.

Also, in the print object information measuring device of one embodiment, the regularly-reflected-ray condenser part is a lens.

According to the print object information measuring device of this embodiment, since the regularly-reflected-ray condenser part is a lens, a small-sized, low-priced print object information measuring device can be realized.

Also, in the print object information measuring device of one embodiment, the objective-side condenser part is a lens.

According to the print object information measuring device of this embodiment, since the objective-side condenser part is a lens, a small-sized, low-priced print object information measuring device can be realized.

Also, in the print object information measuring device of one embodiment, the diffusely-reflected-ray condenser part and the regularly-reflected-ray condenser part are provided by one lens.

According to the print object information measuring device of this embodiment, since the diffusely-reflected-ray condenser part and the regularly-reflected-ray condenser part are provided by one lens, parts count of the optical system can be reduced, so that a lower-priced print object information measuring device which involves less man-hours in its manufacturing process can be realized.

Also, in the print object information measuring device of one embodiment, the diffusely-reflected-ray condenser part, the regularly-reflected-ray condenser part and the objective-side condenser part are provided by one lens.

According to the print object information measuring device of this embodiment, since the diffusely-reflected-ray condenser part, the regularly-reflected-ray condenser part and the objective-side condenser part are provided by one lens, parts count of the optical system can be reduced, so that a smaller-sized, lower-priced print object information measuring device which involves less man-hours in its manufacturing process can be realized.

Also, in the print object information measuring device of one embodiment, the light-emitting-part side condenser part, the diffusely-reflected-ray condenser part, the regularly-reflected-ray condenser part and the objective-side condenser part are provided by one lens.

According to the print object information measuring device of this embodiment, since the light-emitting-part side condenser part, the diffusely-reflected-ray condenser part, the regularly-reflected-ray condenser part and the objective-side condenser part are provided by one lens, parts count of the optical system can be reduced, so that a smaller-sized, lower-priced print object information measuring device which involves less man-hours in its manufacturing process can be realized.

Also, in the print object information measuring device of one embodiment, the lens is a Fresnel lens.

According to the print object information measuring device of this embodiment, since the lens is a Fresnel lens, integration of the lens becomes easily achievable, so that a smaller-sized print object information measuring device can be realized.

Also, in the print object information measuring device of one embodiment, the three light-emitting elements are mounted on one identical board.

According to the print object information measuring device of this embodiment, since the three light-emitting elements are mounted on one identical board, a space saving can be achieved so that a more downsized print object information measuring device can be realized. Moreover, the ratio of the common illumination area to the entire illumination area resulting upon illumination on the print object by the three light-emitting elements can be enhanced, by which the use efficiency of light is enhanced, hence more economical.

Also, in the print object information measuring device of one embodiment, a signal for driving the light-emitting part therewith is modulated in intensity.

According to the print object information measuring device of this embodiment, since a signal for driving the light-emitting part therewith is modulated in intensity, the average current consumption at the light-emitting part can be suppressed, allowing the life of the light-emitting part to elongate, hence economical.

Also, in the print object information measuring device of one embodiment, a signal for driving the light-emitting part therewith is a rectangular wave, and the rectangular wave has a duty ratio of 0.1 or less.

According to the print object information measuring device of this embodiment, by setting the duty ratio of drive pulses for driving the light-emitting part to 0.1 or less, the light quantity of light fluxes generated by the light-emitting part can be increased to a necessary level while the average current consumption is suppressed.

Also, in the print object information measuring device of one embodiment, the light-emitting part emits the plurality of light fluxes in time division.

According to the print object information measuring device of this embodiment, since the light-emitting part emits the plurality of light fluxes in time division, the plurality of light fluxes are never mixed with one another. Thus, the light-receiving part is enabled to output electric signals in correspondence to the mutually different wavelengths, respectively, making it possible to fulfill high-accuracy color information measurement.

Also, in the print object information measuring device of one embodiment, the light-emitting part is provided by light-emitting diodes.

According to the print object information measuring device of this embodiment, since the light-emitting part is provided by light-emitting diodes, a low-priced print object information measuring device can be realized.

Also, in the print object information measuring device of one embodiment, the diffusely-reflected-ray receiving part and the regularly-reflected-ray receiving part are photodiodes.

According to the print object information measuring device of this embodiment, since the diffusely-reflected-ray receiving part and the regularly-reflected-ray receiving part are photodiodes, a low-priced, high-accuracy measurement can be fulfilled.

Also, in the print object information measuring device of one embodiment, the photodiodes of the diffusely-reflected-ray receiving part and the regularly-reflected-ray receiving part are formed on one identical board.

According to the print object information measuring device of this embodiment, since the photodiodes of the diffusely-reflected-ray receiving part and the regularly-reflected-ray receiving part are formed on one identical board, a small-sized print object information measuring device can be provided.

Also, in the print object information measuring device of one embodiment, the diffusely-reflected-ray receiving part and the regularly-reflected-ray receiving part are provided by a divisional photodiode.

According to the print object information measuring device of this embodiment, since the diffusely-reflected-ray receiving part and the regularly-reflected-ray receiving part are provided by a divisional photodiode, a smaller-sized print object information measuring device can be realized.

Also, in the print object information measuring device of one embodiment, the calculation part includes a signal processing part for normalizing an electric signal outputted by the diffusely-reflected-ray receiving part by using a reference signal.

According to the print object information measuring device of this embodiment, since the calculation part includes a signal processing part for normalizing an electric signal outputted by the diffusely-reflected-ray receiving part by using a reference signal, variations of output signals of the diffusely-reflected-ray receiving part that vary due to temperature or other ambient environments can be canceled out by the normalization by the reference signal.

Also, in the print object information measuring device of one embodiment, the calculation part includes a signal processing part for normalizing an electric signal outputted by the regularly-reflected-ray receiving part by using a reference signal.

According to the print object information measuring device of this embodiment, since the calculation part includes a signal processing part for normalizing an electric signal outputted by the regularly-reflected-ray receiving part by using a reference signal, variations of output signals of the diffusely-reflected-ray receiving part that vary due to temperature or other ambient environments can be canceled out by the normalization by the reference signal.

Also, in the print object information measuring device of one embodiment, the signal processing part normalizes an electric signal outputted by the diffusely-reflected-ray receiving part by using an upper-limit reference signal and a lower-limit reference signal.

According to the print object information measuring device of this embodiment, since the signal processing part normalizes an electric signal outputted by the diffusely-reflected-ray receiving part by using an upper-limit reference signal and a lower-limit reference signal, the normalization can be achieved with a fixed scale at all times, allowing the measurement accuracy to be improved.

Also, in the print object information measuring device of one embodiment, the signal processing part normalizes an electric signal outputted by the regularly-reflected-ray receiving part by using an upper-limit reference signal and a lower-limit reference signal.

According to the print object information measuring device of this embodiment, since the signal processing part normalizes an electric signal outputted by the regularly-reflected-ray receiving part by using an upper-limit reference signal and a lower-limit reference signal, the normalization can be achieved with a fixed scale at all times, allowing the measurement accuracy to be improved.

Also, in the print object information measuring device of one embodiment, the upper-limit reference signal is an electric signal which is outputted by the diffusely-reflected-ray receiving part upon its reception of a diffusely reflected ray from a white portion, and

the lower-limit reference signal is an electric signal which is outputted by the diffusely-reflected-ray receiving part upon its reception of a diffusely reflected ray from a black portion.

According to the print object information measuring device of this embodiment, the upper-limit reference signal is an electric signal which is outputted by the diffusely-reflected-ray receiving part upon its reception of a diffusely reflected ray from a white portion, and the lower-limit reference signal is an electric signal which is outputted by the diffusely-reflected-ray receiving part upon its reception of a diffusely reflected ray from a black portion. Therefore, the upper-limit reference signal and the lower-limit reference signal can be fixed, so that color information by electric signals outputted by the diffusely-reflected-ray receiving part can be represented in absolute digital values.

Also, in the print object information measuring device of one embodiment, the upper-limit reference signal is an electric signal which is outputted by the regularly-reflected-ray receiving part upon its reception of a regularly reflected ray from a white portion, and

the lower-limit reference signal is an electric signal which is outputted by the regularly-reflected-ray receiving part upon its reception of a regularly reflected ray from a black portion.

According to the print object information measuring device of this embodiment, the upper-limit reference signal is an electric signal which is outputted by the regularly-reflected-ray receiving part upon its reception of a regularly reflected ray from a white portion, and the lower-limit reference signal is an electric signal which is outputted by the regularly-reflected-ray receiving part upon its reception of a regularly reflected ray from a black portion. Therefore, the upper-limit reference signal and the lower-limit reference signal can be fixed, so that color information by electric signals outputted by the regularly-reflected-ray receiving part can be represented in absolute digital values.

Also, in the print object information measuring device of one embodiment, the calculation part calculates, as positional information on the print object, a position of the print object resulting when an average value of individual wavelengths of normalized outputs of the regularly-reflected-ray receiving part becomes (upper-limit reference signal+lower-limit reference signal)/2.

According to the print object information measuring device of this embodiment, by taking average values by individual wavelengths among normalized outputs of the regularly-reflected-ray receiving part, variations due to wavelengths can be suppressed. Moreover, by detecting a position of the print object resulting when an average value of individual wavelengths of normalized outputs of the regularly-reflected-ray receiving part becomes (upper-limit reference signal+lower-limit reference signal)/2, the position of the print object can be measured accurately and simply.

Also in the present invention, there is provided a printing device which, based on color information and positional information on the print object measured by the print object information measuring device as described above, controls color and position of print objects that are to be printed thereafter.

According to the printing device of this invention, based on color information and positional information on the print object measured by the print object information measuring device, the printing device controls color and position of print objects that are to be printed thereafter. Thus, high-accuracy printing becomes achievable.

As described above, the print object information measuring device of this invention includes a calculation part that calculates color information on the print object by an output derived from at least either the diffusely-reflected-ray receiving part or the regularly-reflected-ray receiving part and that also calculates positional information on the print object by an output derived from the regularly-reflected-ray receiving part. Therefore, color information and positional information on the print object can be measured simultaneously, so that a low-priced, small-sized print object information measuring device can be realized.

Furthermore, the printing device of the invention, based on color information and positional information on the print object measured by the print object information measuring device, controls color and position of print objects that are to be printed thereafter. Thus, a high-accuracy printing becomes achievable.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a schematic view showing a first embodiment of a color information measuring device of the invention;

FIG. 1B is a schematic view showing a modification of the first embodiment;

FIG. 2 is a schematic view showing an example of the construction of a light-emitting part of the first embodiment;

FIG. 3 is a view showing illumination areas which are on a surface of a measurement object and which are of three light fluxes applied to the measurement object by the light-emitting part 20 of the first embodiment;

FIG. 4 is a timing chart showing timing of light reception and emission in the first embodiment;

FIG. 5 is a graph showing an example of normalization of light-reception signals outputted by a photodiode in the first embodiment;

FIG. 6A is a schematic view showing a second embodiment of the color information measuring device of the invention;

FIG. 6B is a schematic view showing a modification of the second embodiment shown in FIG. 6A;

FIG. 7A is a schematic view showing another modification of the second embodiment;

FIG. 7B is a schematic view showing a modification of the modification shown in FIG. 7A;

FIG. 8A is a schematic view showing a third embodiment of the color information measuring device of the invention;

FIG. 8B is a schematic view showing a modification of the third embodiment;

FIG. 9 is a perspective view showing a structure of a diffraction grating, which is as an example of a wavelength selector section, and a divisional photodiode included in the third embodiment;

FIG. 10 is a schematic view showing a fourth embodiment of the print object information measuring device of the invention;

FIG. 11 is a schematic view showing a construction of the light-emitting part;

FIG. 12 is a plan view showing illumination areas which are on the sheet and which are of three light fluxes applied by the light-emitting part, as well as observation areas on the sheet where reflected light from the sheet can be received by a diffusely-reflected-ray photodiode and a regularly-reflected-ray photodiode;

FIG. 13A is a schematic view showing a construction of a diffusely-reflected-ray slit portion;

FIG. 13B is a schematic view showing a construction of a regularly-reflected-ray slit portion;

FIG. 14 is a graph showing normalization of light-reception signals outputted by the diffusely-reflected-ray photodiode;

FIG. 15 is a graph showing normalization of light-reception signals outputted by the regularly-reflected-ray photodiode;

FIG. 16 is a block diagram showing a calculation section;

FIG. 17 is a timing chart showing timing of light reception and emission;

FIG. 18 is a schematic view showing a fifth embodiment of the print object information measuring device of the invention;

FIG. 19 is a schematic view showing a sixth embodiment of the print object information measuring device of the invention;

FIG. 20 is a schematic view showing a seventh embodiment of the print object information measuring device of the invention;

FIG. 21A is a schematic view showing a color sensor of a prior art;

FIG. 21B is a schematic view showing a construction of a light-receiving element of the of the color sensor of the prior art; and

FIG. 22 is a schematic view showing a sheet position detection device of a prior art.

### DETAILED DESCRIPTION OF THE INVENTION

Hereinbelow, embodiments of the present invention will be described in detail with reference to the accompanying drawings.

### First Embodiment

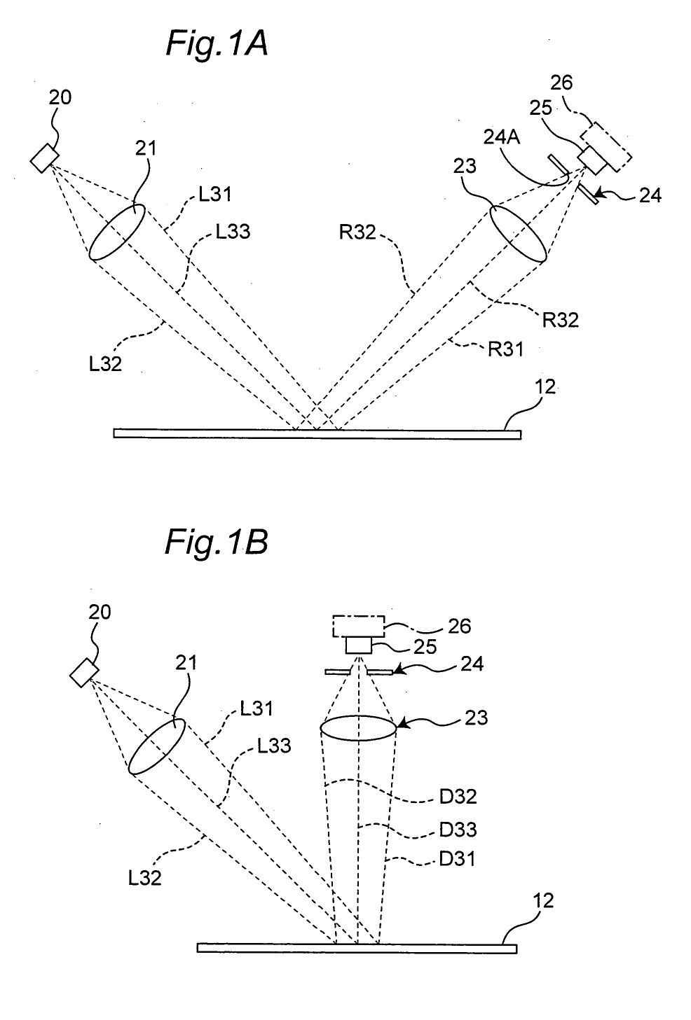

FIG. 1A show a first embodiment of the color information measuring device of the invention. This first embodiment includes a light-emitting part 20, an illuminating lens 21 as an illuminating part, a condenser lens 23 as a condenser part, a slit member 24 and a photodiode 25 as a light-receiving element. The slit member 24 is placed between the condenser lens 23 and the photodiode 25 and has a slit 24A.

The light-emitting part 20 has an LED group composed of a plurality of light-emitting diodes that differ in emission wavelength from one another. Light-emitting diodes, which are low in price and long in life and which are mass produced in various emission spectra over the entire visible region, have some degree of freedom of design, thus being suited to constitute the light-emitting part of the color information measuring device (i.e., color sensor). In general, since a color sensor operates on the principle of measuring reflectivity of the measurement object in each wavelength, it is desirable that emission spectra by the LED group stretch over the entire visible region. However, using a multiplicity of LEDs of different emission wavelengths to cover the entire visible region, which would cause cost increases, is undesirable.

Thus, in order to satisfy contradictory two demands, the broadband property and the cost reduction, in this first embodiment, the LED group emits three different wavelengths. That is, the light-emitting part 20 has three light-emitting diodes that differ in emission wavelength from one another. Also, the three different emission wavelengths by the three light-emitting diodes are preferably red, green and blue. That is, setting the three wavelengths in correspondence to red, green and blue, respectively, makes it possible that the spectral distribution of the three light fluxes emitted from the three light-emitting diodes is that the visible region is divided into generally equally three portions along the wavelength axis. Accordingly, with the above setting, the three light fluxes emitted from the three light-emitting diodes are enabled to cover the entire visible region efficiently.

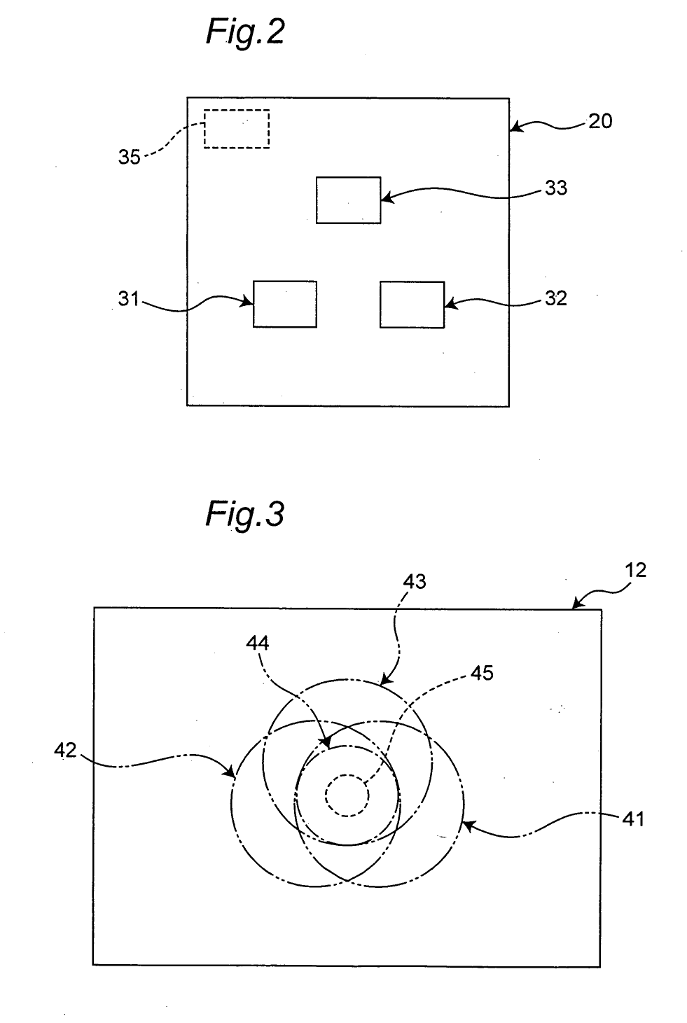

Next, the plan view of FIG. 2 schematically shows an example of the construction of the light-emitting part 20. This light-emitting part 20 has a red light-emitting diode 31, a green light-emitting diode 32 and a blue light-emitting diode 33. Referring to FIG. 2, the light-emitting diode 31, 32, 33 are mounted on one board 30 and placed generally at vertices of an imaginary triangle. Like this, light-emitting diode chips forming the three light-emitting diodes 31-33, respectively, are mounted on one board 30, by which the optical system of the light-emitting part 20 can be reduced in size.

As shown in FIG. 1A, the illuminating lens 21 as an illuminating part condenses three light fluxes L31-L33 emitted from the three light-emitting diodes 31-33 of the light-emitting part 20, and applies them to the measurement object 12. Thus, using the illuminating lens 21 as an illuminating part makes it possible to condense the light fluxes of the respective light-emitting diodes 31-33 with an inexpensive means.

Next, FIG. 3 shows a state in which three light fluxes L31-L33 emitted from the respective light-emitting diodes 31-33 of the light-emitting part 20 are applied to the surface of the measurement object 12 via the illuminating lens 21. Referring to FIG. 3, reference numeral 41 denotes an illumination area of the light flux L31 derived from the red light-emitting diode 31, 42 denotes an illumination area of the light flux L32 derived from the green light-emitting diode 32, and 43 denotes an illumination area of the light flux L33 derived from the blue light-emitting diode 33. Also, as shown in FIG. 3, the three light fluxes L31 to L33 have a common illumination area 44 on the surface of the measurement object 12. Such an area on the measurement object 12 where reflected rays R31-R33 of the three light fluxes L31-L33 comes incident on the photodiode 25 via the lens 23 of FIG. 1A and the slit 24A of the slit member 24 at the measurement object 12 is shown as an observation area 45 surrounded by broken line in FIG. 3.

As shown in FIG. 3, the observation area 45 is smaller than the common illumination area 44, and the common illumination area 44 contains the observation area 45. Accordingly, the photodiode 25 receives the three-color reflected rays R31-R33 derived from the observation area 45 contained in the common illumination area 44 in which the illumination areas 41-43 by the three light fluxes L31-L33 overlap with one another. Thus, by an electric signal outputted by the photodiode 25, intensities of the three reflected rays R31-R33 derived from one identical area (observation area 45) can be observed equivalently, so that the measurement accuracy is improved.

Also in this embodiment, by forming the condenser part with the condenser lens, the reflected rays R31-R33 derived from the measurement object 12 can be condensed toward the photodiode 25 with high efficiency. Also in this embodiment, the light-receiving element, which is formed from the photodiode 25, can be manufactured with low cost. The three reflected rays R31-R33 derived from the measurement object 12 are condensed by the condenser lens 13 onto the photodiode 25 via the slit member 24 and converted into three electric signals proportional to light intensities of the three reflected rays R31-R33, respectively.

In general, the light-receiving part of the photodiode is rectangular-shaped, and so when the observation area 45 corresponding to the photodiode 25 is desired to be circular-shaped, it is desirable that the slit member 24 having a circular-shaped slit 24A be placed between the condenser lens 23 and the photodiode 25. Also, the slit member 24 has advantages of the capabilities of shutting off unnecessary disturbance light and improving the S/N ratio of light-reception signals. Depending on the diameter of the slit 24A of the slit member 24, the observation area 45 corresponding to the photodiode 25 can be set to a desired diameter. On the assumption that, as an example, this color information measuring device is mounted onto a printing machine to monitor the printing state of the printing machine, the diameter of the observation area 45 corresponding to the photodiode 25 is desirably not more than 2 mm. Setting the diameter of the observation area 45 to not more than 2 mm makes it possible to fulfill a high-resolution measurement of the printing state.

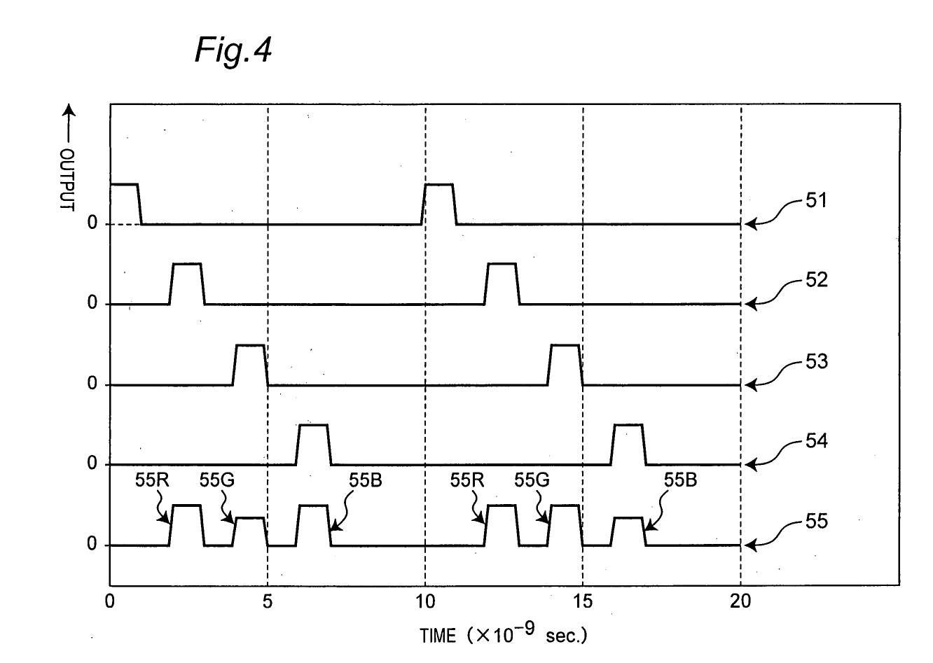

In this embodiment, timing of light reception and emission is controlled by a time-division light reception and emission method. FIG. 4 shows a timing chart for this timing of light reception and emission. First, as an example, a light-emitting-element drive part 35 mounted on the board 30 shown in FIG. 2 generates a trigger signal 51 having a pulse waveform of a specified period, and the trigger signal 51 is used as a reference for every signal. That is, by the light-emitting-element drive part 35, a signal delayed by a specified time from the trigger signal 51 is set as a drive signal 52 to be inputted to the red light-emitting diode 31, and a signal delayed by a specified time from the drive signal 52 is set as a drive signal 53 to be inputted to the green light-emitting diode 32. Also, a signal delayed by a specified time from the drive signal 52 is set as a drive signal 54 to be inputted to the blue light-emitting diode 33.

Thus, the electric signal outputted in response to the intensity of light received by the photodiode 25 results in a light-reception signal 55 shown in FIG. 4. The light-reception signal 55 outputted by the photodiode 25 is inputted to a signal processing part 26 provided adjacent to the photodiode 25 as shown in FIG. 1A. The signal processing part 26, which operates in synchronism with the trigger signal 51 outputted by the light-emitting-element drive part 35 mounted on the board 30, is enabled to acquire, in time division from the inputted light-reception signal 55, three light intensity signals 55R, 55G, 55B proportional to the light intensities of the reflected rays R31-R33 of red, green and blue three colors.

Also, as shown in FIG. 4, the drive signals 52-54 are driven in pulses, desirably, with a duty of 0.1 or less. Decreasing the duty by the pulse drive method makes it possible to obtain emission power of larger light quantities with the average current consumption unchanged, as compared with the DC (Direct Current) drive method. In other words, when a certain quantity of light is emitted by the pulse drive method and the DC drive method, the pulse drive method results in smaller average current consumption, hence economical. Further, the pulse drive method is superior in the life of LEDs as well as in heat radiation over the DC drive method, and so the output is stabilized.

In this embodiment, the light-reception signal 55 shown in FIG. 4 makes it possible to obtain signals 55R, 55G, 55B proportional to the received light intensities of the three reflected rays R31-R33, respectively. However, the electric signal outputted by the photodiode 25 varies depending on ambient environments such as temperature, and therefore, desirably, normalized with some reference signal.

More specifically, in order for the signal processing part 26 to fulfill accurate measurement based on an electric signal outputted by the photodiode 25, as an example of the normalization, first, an upper-limit reference signal and a lower-limit reference signal are determined. That is, to digitize color information based on the signals 55R, 55G, 55B of the light-reception signal 55, the signal processing part 26 sets beforehand fixed upper-limit reference signal and lower-limit reference signal as a part corresponding to a scale for the digitization. These upper-limit reference signal and lower-limit reference signal serve as absolute references. In addition, in this embodiment, as an example, an electric signal outputted by the photodiode 25 upon reception of reflected light from a white portion of the measurement object 12 is assumed as the upper-limit reference signal, and an electric signal outputted by the photodiode 25 upon reception of reflected light from a black portion of the measurement object 12 is assumed as the lower-limit reference signal.

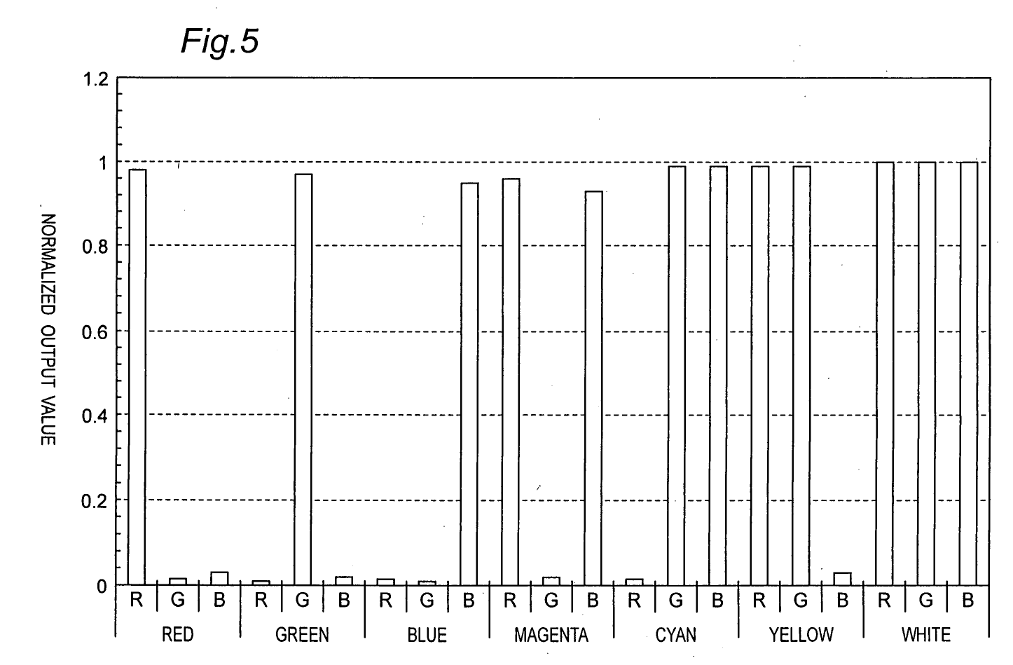

Referring to FIG. 5, a concrete example of the normalization is explained. Individual items of ‘R’, ‘G’ and ‘B’ in the horizontal axis of FIG. 5 correspond to light-reception signals 55R, 55G, 55B, respectively, outputted by the photodiode 25 when light fluxes L31, L32, L33 derived from the red, green and blue light-emitting diodes 31, 32, 33 are reflected by the observation area 45 to be incident on the photodiode 25. Also, individual fields of ‘RED’, ‘GREEN’, ‘BLUE’, ‘MAGENTA’, ‘CYAN ’, ‘YELLOW’ and ‘WHITE’ in the horizontal axis of FIG. 5 represent cases where the observation area 45 of the measurement object 12 is red, green, blue, magenta, cyan, yellow and white, respectively. The vertical axis of FIG. 5 represents output values resulting from the normalization of the light-reception signals 55R, 55G, 55B corresponding to the three-color reflected rays R31-R33, respectively, by the lower-limit reference signal and the upper-limit reference signal.

Items ‘R’, ‘G’ and ‘B’ in the field of ‘WHITE’ in the horizontal axis of FIG. 5 represent values resulting from the normalization of the light-reception signals 55R, 55G, 55B of the photodiode 25 that has received the three-color reflected rays R31-R33 derived from the white portion of the measurement object 12. In this embodiment, since the white portion of the measurement object 12 corresponds to the upper-limit reference signal, the individual normalized values of ‘R’, ‘G’ and ‘B’ are each 1.

Items ‘R’, ‘G’ and ‘B’ in the field of ‘RED’ in the horizontal axis of FIG. 5 represent values resulting from the normalization of the light-reception signals 55R, 55G, 55B of the photodiode 25 that has received the three-color reflected rays R31-R33 derived from the red portion of the measurement object 12. When the observation area 45 of the measurement object 12 is red-colored, there results a high signal output of the light-reception signal 55R by the reflected ray R31 originating from the light flux L31 derived from the red light-emitting diode 31 and reflected by the observation area 45. Therefore, the normalized value of the item ‘R’ in the field of ‘RED’ is close to 1, which is comparable to the normalized value of item ‘R’ in the field of ‘WHITE’ in the case where the observation area 45 of the measurement object 12 is a white portion.

In the field of ‘GREEN’, where the observation area 45 is green-colored, the normalized value of the item ‘G’ is close to 1, while the normalized values of the other items ‘R’ and ‘B’ are as small as correspondent to the case where the observation area 45 is a black portion (lower-limit reference signal). Similarly, in the field of ‘BLUE’, where the observation area 45 is blue-colored, the normalized value of the item ‘B’ is close to 1, while the normalized values of the other items ‘R’ and ‘G’ are as small as correspondent to the case where the observation area 45 is a black portion (lower-limit reference signal).

Likewise, in the fields of ‘MAGENTA’, ‘CYAN’ and ‘YELLOW’ in the horizontal axis of FIG. 5, normalized values of ‘R’, ‘G’ and ‘B’ in cases where the observation area 45 of the measurement object 12 is magenta-, cyan- and yellow-colored, respectively, are shown. The same thing applies also to the case where the observation area 45 of the measurement object 12 is mixture-colored. For example, when the observation area 45 of the measurement object 12 is magenta-colored (mixed color of red and blue), the normalized value of the item ‘R’ and the normalized value of the item ‘B’ become about 1, while the normalized value of the item ‘G’ is about 0.

In this way, the signal processing part 26 outputs, as color information, signals representing values resulting from normalizing, by the upper-limit reference signal and the lower-limit reference signal, the light-reception signals 55R, 55G, 55B corresponding to the three-color reflected rays R31-R33, respectively, in proportion to red, green and blue color components of the observation area 45 of the measurement object 12. By keeping management of the color information, for example, this color information measuring device is enabled to normally monitor the printing state of the printer.

In this embodiment, as shown in FIG. 1A, the condenser lens 23, the slit member 24 and the photodiode 25 are so placed that the regularly reflected rays R31-R33 resulting from regular reflection of the light fluxes L31-L33 derived from the light-emitting part 20 by the measurement object 12 are received by the photodiode 25. Alternatively, as shown in FIG. 1B, the condenser lens 23, the slit member 24 and the photodiode 25 may also be so placed that the diffusely reflected rays D31-D33 resulting from diffuse reflection of the light fluxes L31-L33 derived from the light-emitting part 20 by the measurement object 12 are received by the photodiode 25. Furthermore, although the light-emitting part 20 includes the red, green and blue light-emitting diodes 31, 32, 33 in this embodiment, yet light-emitting diodes included in the light-emitting part may be two or four or more light-emitting diodes for generating light of mutually different colors other than red, green and blue.

### Second Embodiment

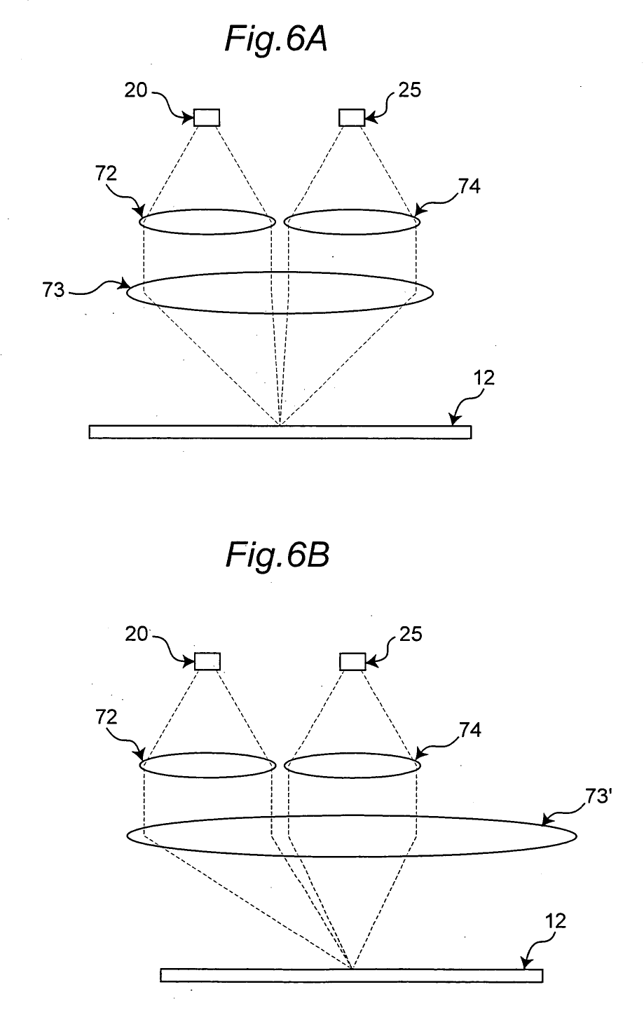

Next, FIG. 6A shows a second embodiment of the color information measuring device of the invention. This second embodiment has no slit member 24 of the first embodiment and its light-emitting part 20 and photodiode 25 are similar in construction to those of the foregoing first embodiment. The second embodiment is explained below in terms of its differences from the first embodiment.

As shown in FIG. 6A, in this second embodiment, an output optical axis of the light-emitting part 20 and an input optical axis of the photodiode 25 are generally perpendicular to the surface of the measurement object 12. In this second embodiment, a lens 72 is included, and each light flux emitted from the light-emitting part 20 is collimated by the lens 72. Each collimated light flux goes incident on a Fresnel lens 73. The Fresnel lens 73 serves as both an illuminating part and a condenser part. The Fresnel lens 73 acts to make each collimated light flux, which is derived from the lens 72, incident on the illumination area 44 of the measurement object 12. Each reflected ray reflected by the observation area 45 within the illumination area 44 goes incident on the Fresnel lens 73 again and, after being condensed by a lens 74, goes incident on the photodiode 25.

In this second embodiment, each light flux emitted from the light-emitting part 20 is once collimated by the lens 72. By the conversion into collimated light, a focal length from the light-emitting part 20 to the lens 72 and a focal length from the Fresnel lens 73 to the measurement object 12 can be shortened. Therefore, the color information measuring system including this color information measuring device can be downsized as a whole. Also, structurally, it becomes practicable to place the light-emitting part 20 and the light-receiving element 25 on one identical imaginary plane, making it possible to mount both the light-emitting part 20 and the light-receiving element 25 on one board. Thus, according to this second embodiment, the color information measuring device itself can be downsized, compared with the foregoing first embodiment.

In this embodiment, the Fresnel lens 73 is a lens in which a portion of the illuminating part and a portion of the condenser part are integrated together. This integration makes it possible to downsize the color information measuring system including this color information measuring device as a whole optical system. It is noted here that the term “Fresnel lens” refers to a lens which is reduced in a wall thickness of its portion through which light inside the lens travels straight so that its thickness is reduced as compared with ordinary spherical lenses. By doing so, a short-focal-length, bright lens which is smaller in F value than ordinary spherical lenses can be realized. Accordingly, as in this embodiment, the lens adopted in the illuminating part and the condenser part is preferably replaced with a Fresnel lens because successful optical characteristics can be obtained.

In FIG. 6A, the light-emitting part 20, the illuminating lens 72, the Fresnel lens 73, the condenser lens 74 and the photodiode 25 are so placed that the regularly reflected rays resulting from regular reflection of the light fluxes derived from the light-emitting part 20 by the measurement object 12 are received by the photodiode 25. Alternatively, as shown in FIG. 6B, the light-emitting part 20, the illuminating lens 72, the Fresnel lens 73′, the condenser lens 74 and the photodiode 25 may also be so placed that the diffusely reflected rays resulting from diffuse reflection of the light fluxes derived from the light-emitting part 20 by the measurement object 12 are received by the photodiode 25.

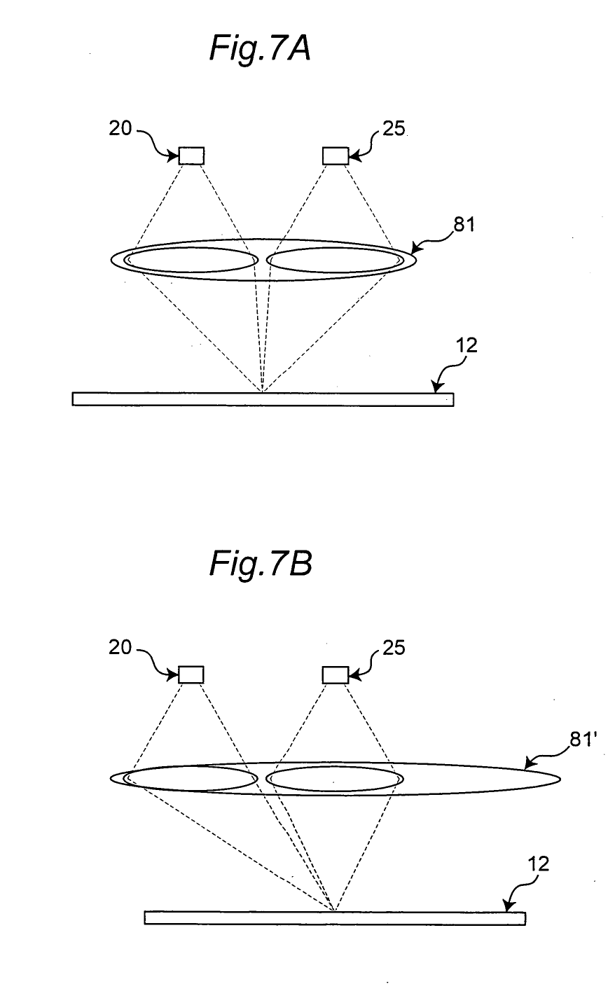

Next, FIG. 7A shows a modification of the second embodiment. In this modification, an integrated Fresnel lens 81 in which the illuminating lens 72, the Fresnel lens 73 and the condenser lens 74 are integrated into one lens is included instead of the illuminating lens 72, the Fresnel lens 73 and the condenser lens 74 of FIG. 6A. The inclusion of the integrated Fresnel lens 81 like this makes it possible to reduce the parts count, hence a low cost of manufacture.

Further, in this modification, although the focal length from the integrated Fresnel lens 81 to the measurement object 12 is longer as compared with the focal length from the illuminating lens 72 to the measurement object 12 in FIG. 6A, yet the optical system becomes more compact and the color information measuring device itself can be downsized. In addition, FIG. 7A shows a structure in which regularly reflected rays resulting from regular reflection of the light fluxes derived from the light-emitting part 20 by the measurement object 12 are received by the photodiode 25. However, as shown in FIG. 7B, the structure may be such that diffusely reflected rays resulting from diffuse reflection of the light fluxes derived from the light-emitting part 20 by the measurement object 12 are received by the photodiode 25.

It is noted that the signal processing part 26 is not shown in FIGS. 6A, 6B, 7A and 7B.

### Third Embodiment

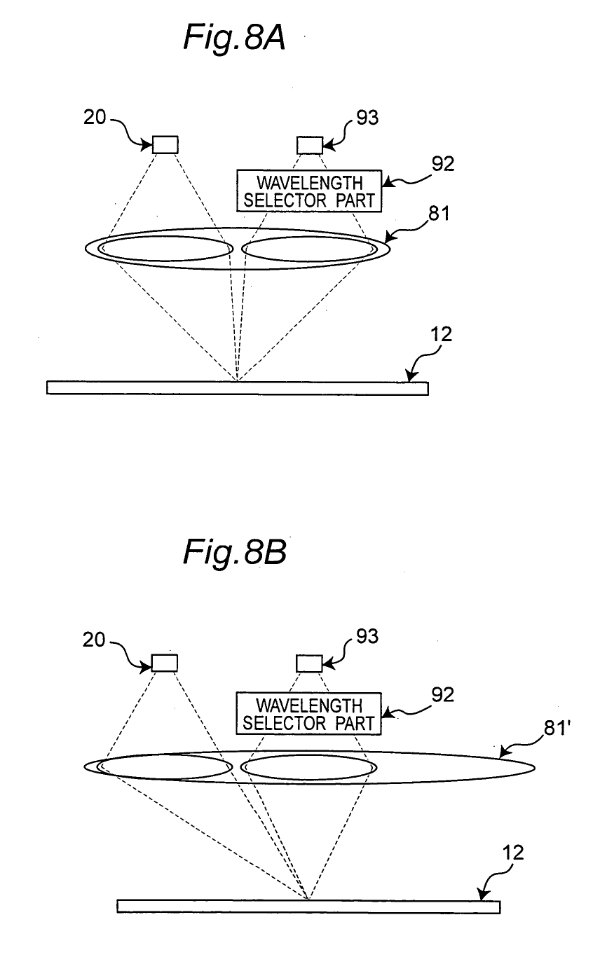

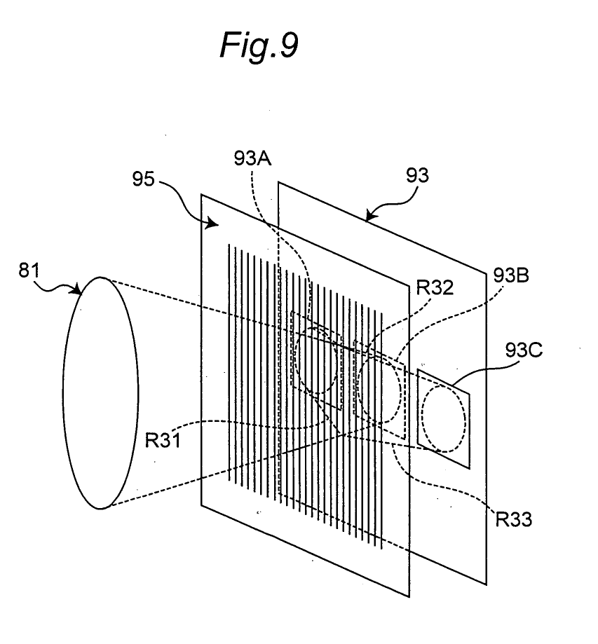

Next, FIG. 8A shows a third embodiment of the invention. This third embodiment includes the three light-emitting diodes 31-33 of the light-emitting part 20 and the integrated Fresnel lens 81, as in the foregoing modification of FIG. 7A. On the other hand, the third embodiment differs from the modification of FIG. 7A in that a divisional photodiode 93 is included instead of the photodiode 25 and that a wavelength selector part 92 is placed between the divisional photodiode 93 and the integrated Fresnel lens 81.

Also, the third embodiment differs from the first and second embodiments in that the light-emitting-element drive part 35, which is shown as an example in FIG. 2, drives the three light-emitting diodes 31-33 of the light-emitting part 20 to emit light simultaneously.

In this third embodiment, the emission method that the three light-emitting diodes 31-33 are driven for simultaneous emission may be either a DC drive method or a pulse drive method, but desirably, it should be driven in pulses in consideration of current consumption. Each light flux emitted from the light-emitting part 20, as in the modification of the second embodiment, is illuminated by the integrated Fresnel lens 81 on the measurement object 12 and is reflected by the observation area 45 of the measurement object 12, going incident on the integrated Fresnel lens 81 again as a reflected light flux. The reflected light flux condensed by the integrated Fresnel lens 81 goes incident on the divisional photodiode 93 via the wavelength selector part 92.

In one example of FIG. 9, a diffraction grating 95 as the wavelength selector part 92 is shown, and the divisional photodiode 93 has three independent light-receiving portions 93A, 93B, 93C. The light flux condensed by the integrated Fresnel lens 81 passes through a diffraction grating 101. When this occurs, the reflected light flux is diffracted by the diffraction grating 101 with a diffraction angle responsive to the wavelength so as to be incident on any one of the light-receiving portions 93A, 93B, 93C of the divisional photodiode 93. As an example, as shown in FIG. 9, a red reflected ray R31 diffracted by the diffraction grating 95, which forms the wavelength selector element 92, becomes incident on the light-receiving portion 93A, a green reflected ray R32 diffracted by the diffraction grating 95 becomes incident on the light-receiving portion 93B, and a blue reflected ray R33 diffracted by the diffraction grating 95 becomes incident on the light-receiving portion 93C.

In this embodiment, a spot diameter at each of the light-receiving portions 93A-93C of the divisional photodiode 93 is so set as to be enough smaller than those of the light-receiving portions 93A-93C. Using the diffraction grating 95 as the wavelength selector part 92 as in this embodiment makes it possible to realize a wavelength selector means which is lower in cost, compared with cases where a wavelength filter is used.

In FIG. 8A, the light-emitting part 20, the integrated Fresnel lens 81, the wavelength selector part 92 and the divisional photodiode 93 are so placed that the regularly reflected rays resulting from regular reflection of the light fluxes derived from the light-emitting part 20 by the measurement object 12 are received by the divisional photodiode 93. Alternatively, as shown in FIG. 8B, the light-emitting part 20, the integrated Fresnel lens 81′, the wavelength selector part 92 and the divisional photodiode 93 may also be so placed that the diffusely reflected rays resulting from diffuse reflection of the light fluxes derived from the light-emitting part 20 by the measurement object 12 are received by the divisional photodiode 93. Also, with the use of electronic equipment (printer as an example) which includes the above color information measuring device and which is functionally controlled by electric signals outputted by the color information measuring device, the color information measuring device makes it possible to implement high-precision functional control, so that small-sized, high-performance electronic equipment can be realized. Further, although photodiodes are adopted as the light-receiving element in this embodiment, it is also possible to adopt other light-receiving elements such as phototransistors and photo ICs.

### Fourth Embodiment

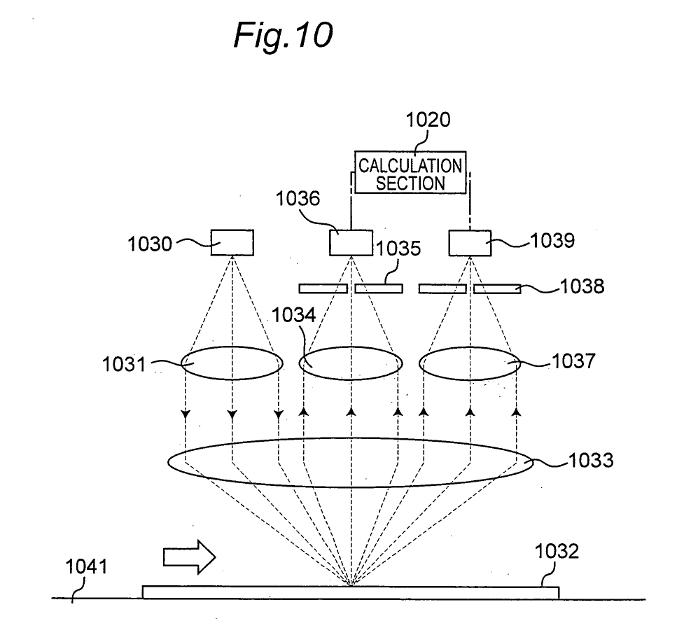

FIG. 10 is a schematic view showing a fourth embodiment of a print object information measuring device of the invention. This print object information measuring device measures color information and positional information on a print object to be outputted from a printing device. The printing device is, for example, a color printer or a color copier. The print object is, for example, an OHP or paper sheet. More specifically, the print object information measuring device measures color information and positional information on a sheet 1032 printed by the printing device, the measurement being done on a casing 41 of the printing device. That is, the print object information measuring device, which is a sheet information sensor, performs measurement in a direction orthogonal to the conveyance direction of the sheet 1032 indicated by an arrow.

This sheet information sensor includes a light-emitting part 1030, a light-emitting condenser lens 1031 as a light-emitting-part side condenser part, an objective condenser lens 1033 as an objective-side condenser part, a diffusely-reflected-ray condenser lens 1034 as a diffusely-reflected-ray condenser part, a diffusely-reflected-ray slit portion 1035, a diffusely-reflected-ray photodiode 1036 as a diffusely-reflected-ray receiving portion, a regularly-reflected-ray condenser lens 1037 as a regularly-reflected-ray condenser part, a regularly-reflected-ray slit portion 1038, a regularly-reflected-ray photodiode 1039 as a regularly-reflected-ray receiving portion, and a calculation section 1020.

The light-emitting part 1030 emits a plurality of light fluxes having mutually different wavelengths. The light-emitting condenser lens 1031 converts each light flux derived from the light-emitting part 1030 into a generally parallel collimated light.

The objective condenser lens 1033 applies the collimated light, which is derived from the light-emitting condenser lens 1031, onto the sheet 1032 and moreover converts diffusely reflected rays and regularly reflected rays, which are derived from the sheet 1032, into collimated light of generally parallel state, respectively.

The diffusely-reflected-ray photodiode 1036 converts a diffusely reflected ray, which is derived from the sheet 1032, into an electric signal. The regularly-reflected-ray photodiode 1039 converts a regularly reflected ray, which is derived from the sheet 1032, into an electric signal.

The diffusely-reflected-ray condenser lens 1034, which is positioned between the objective condenser lens 1033 and the diffusely-reflected-ray photodiode 1036, condenses the collimated light, which is derived from the objective condenser lens 1033, onto the diffusely-reflected-ray photodiode 1036.

The regularly-reflected-ray condenser lens 1037, which is positioned between the objective condenser lens 1033 and the regularly-reflected-ray photodiode 1039, condenses the collimated light, which is derived from the objective condenser lens 1033, onto the regularly-reflected-ray photodiode 1039.

The diffusely-reflected-ray slit portion 1035 is placed between the diffusely-reflected-ray condenser lens 1034 and the diffusely-reflected-ray photodiode 1036, and has a slit. The regularly-reflected-ray slit portion 1038 is placed between the regularly-reflected-ray condenser lens 1037 and the regularly-reflected-ray photodiode 1039 and has a slit.

The calculation section 1020 calculates color information on the sheet 1032 by an output from at least either one of the diffusely-reflected-ray photodiode 1036 and the regularly-reflected-ray photodiode 1039, and moreover calculates positional information to the sheet 1032 by an output from the regularly-reflected-ray photodiode 1039. Color tone of the sheet 1032 is measured by the diffusely-reflected-ray photodiode 1036. Gloss and position of the sheet 1032 are measured by the regularly-reflected-ray photodiode 1039.

The light-emitting part 1030 has light-emitting diodes (LEDs) as a plurality of light-emitting elements. These plural LEDs differ in emission wavelength from one another. The LEDs, which are low-priced and long in life and mass-produced in various emission spectra over the entire visible region, have some degree of freedom of design so as to be suited to forming the light-emitting part 1030 of the sheet information sensor.

In general, for measurement of color information on an object, since the sheet reflectivity in each wavelength is measured, it is desirable that the emission spectra by the LEDs stretch over the entire visible region. However, using a multiplicity of LEDs of different emission wavelengths to cover the entire visible region would cause an increase in cost, thus undesirable.

Thus, in order to satisfy contradictory two demands, the broadband property and the cost reduction, in this fourth embodiment, the LED group emits three different wavelengths. That is, the light-emitting part 1030 has three LEDs that differ in emission wavelength from one another. Also, the three different emission wavelengths by the three LEDs are preferably three colors of R (Red), G (Green) and B (Blue). That is, by setting the three wavelengths in correspondence to R, G and B, respectively, it becomes possible that the spectral distribution of the three light fluxes emitted from the three LEDs corresponds to the visible region which is divided into generally equally three portions along the wavelength axis. Accordingly, with the above setting, the three light fluxes emitted from the three LEDs are enabled to cover the entire visible region efficiently.

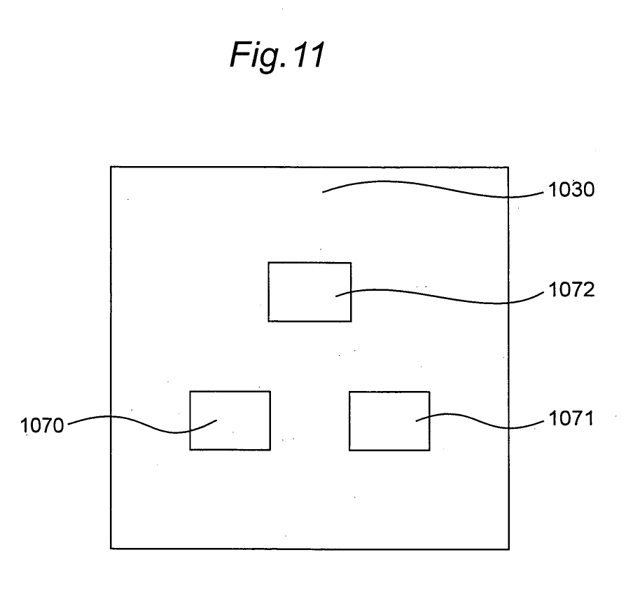

Now an example of the structure of the light-emitting part 1030 is schematically shown in the plan view of FIG. 11. This light-emitting part 1030 has a red light-emitting diode (LED-R) 1070, a green light-emitting diode (LED-G) 1071, and a blue light-emitting diode (LED-B) 1072. In FIG. 11, each of the LEDs 1070, 1071, 1072 are mounted on one identical board and placed generally at vertices of an imaginary triangle.

As shown above, since the three LEDs 1070, 1071, 1072 are mounted on one identical board, a space saving can be achieved so that a more downsized print object information measuring device can be provided. Further, the three LEDs 1070, 1071, 1072 make it possible to enhance the ratio of the common illumination area to the entire illumination area resulting upon illumination on the sheet 1032, by which the use efficiency of light is enhanced, hence economical. It is noted that the placement of the LEDs 1070, 1071, 1072 is not limited to the above one.

Light fluxes of R, G and B emitted from the LEDs 1070, 1071, 1072 are converted into generally collimated light by the light-emitting condenser lens 1031, and further applied onto the sheet 1032 by the objective condenser lens 1033.

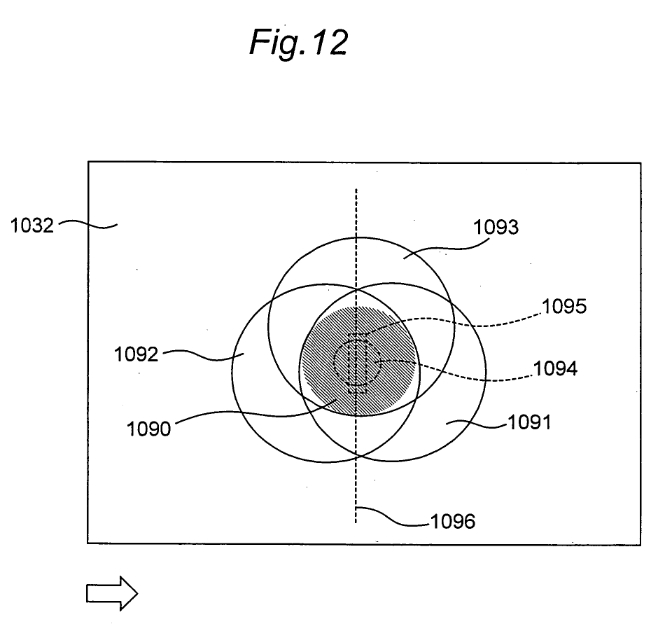

FIG. 12 shows a state in which that light fluxes emitted from the LEDs 1070, 1071, 1072 of the light-emitting part 1030 are applied onto the surface of the sheet 1032 via the light-emitting condenser lens 1031 and the objective condenser lens 1033. An area 1091 is an illumination area of the light flux derived from the red light-emitting diode 1070, an illumination area 1092 is an illumination area of the light flux derived from the green light-emitting diode 1071, and an illumination area 1093 is an illumination area of the light flux derived from the blue light-emitting diode 1072. The three light illumination areas 1091, 1092, 1093 have a common illumination area 1090, which is shown by hatching, on the surface of the sheet 1032.

Further, as shown in FIG. 10, rays reflected by the sheet 1032 are converted into collimated light again by the objective condenser lens 1033. A diffusely-reflected-ray component is condensed by the diffusely-reflected-ray condenser lens 1034 onto the diffusely-reflected-ray photodiode 1036. Meanwhile, a regularly-reflected-ray component is condensed onto the regularly-reflected-ray photodiode 1039 by the regularly-reflected-ray condenser lens 1037. Then, the ray components are converted into electric signals proportional to light-reception amounts at the photodiodes 1036, 1039, respectively.

Since the light-emitting-part side condenser part, diffusely-reflected-ray condenser part, the regularly-reflected-ray condenser part and the objective-side condenser part are given by lenses, respectively, light fluxes can be condensed with low cost and high efficiency, so that a small-size, low-price sheet information sensor can be realized.

Also, since the light-emitting part 1030 is composed of light-emitting diodes, a low-priced sheet information sensor can be realized. Further, since the diffusely-reflected-ray receiving part and the regularly-reflected-ray receiving part are composed of photodiodes, a low-priced, high-accuracy measurement can be achieved.

Areas 1094, 1095 indicated by broken line in FIG. 12 are areas on the sheet 1032, reflected light from which can be received by the photodiodes 1036, 1039 and which are referred to as observation area of the photodiodes 1036, 1039. The area 1094, which shows an observation area of the diffusely-reflected-ray photodiode 1036, is referred to as diffusely-reflected-ray observation area. The area 1095, which shows an observation area of the regularly-reflected-ray photodiode 1039, is referred to as regularly-reflected-ray observation area.

The observation areas 1094, 1095 are smaller than the common illumination area 1090, and the common illumination area 1090 contains the observation areas 1094, 1095. Accordingly, the photodiodes 1036, 1039 receive three-color reflected rays derived from the observation areas 1094, 1095 contained in the common illumination area 1090 in which the R, G and B illumination areas 1091, 1092, 1093 overlap with one another.

In other words, the common illumination area 1090 contains such a diffusely-reflected-ray observation area 1094 that the diffusely reflected ray is made to be incident on the diffusely-reflected-ray photodiode 1036 via the objective condenser lens 1033, the diffusely-reflected-ray condenser lens 1034 and the slit of the diffusely-reflected-ray slit portion 1035. On the other hand, the common illumination area 1090 contains such a regularly-reflected-ray observation area 1095 that the regularly reflected ray is made to be incident on the regularly-reflected-ray photodiode 1039 via the objective condenser lens 1033, the regularly-reflected-ray condenser lens 1037 and the slit of the regularly-reflected-ray slit portion 1038.

Therefore, intensities of three reflected rays derived from one identical area (the common illumination area 1090) can be observed equivalently, so that the measurement accuracy is improved. Further, forming the slits of the slit portions 1035, 1038 into circular, rectangular or other shape allows the photodiodes 1036, 1039 to be changed in shape, making it possible to make up desired shapes of observation areas. Also, the slits have advantages of the capabilities of shutting off unnecessary disturbance light and improving the S/N ratio of light-reception signals.

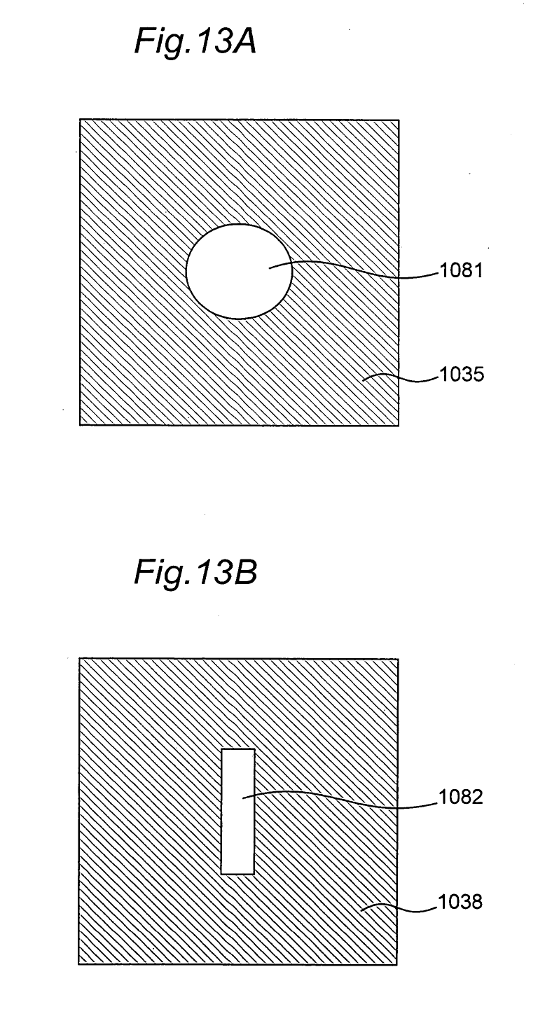

The diffusely-reflected-ray slit portion 1035, as shown in FIG. 13A, has a circular-shaped slit 1081. Therefore, as shown in FIG. 12, the diffusely-reflected-ray observation area 1094 can be made circular-shaped. Thus, by forming the diffusely-reflected-ray observation area 1094 into a circular shape, which is a set of points equidistant from its center, it becomes possible to set the center of the circle to a desired point of measurement so as to determine the spatial resolution corresponding to the radius of the circle, producing an advantage that the light quantity can be ensured efficiently. Accordingly, the diffusely-reflected-ray observation area 1094 is optimally a circular-shaped area.

Meanwhile, the regularly-reflected-ray slit portion 1038, as shown in FIG. 13B, has a rectangular-shaped slit 1082. Therefore, as shown in FIG. 12, the regularly-reflected-ray observation area 1095 can be made rectangular-shaped.

From the regularly-reflected-ray photodiode 1039, primarily, a position relative to a feed direction of the sheet 1032 shown by the arrow in FIG. 12 is measured. This gives rise to a necessity of setting the spatial resolution to a small one with respect to the feed direction of the sheet 1032.

In this connection, reducing the size of the slit of the regularly-reflected-ray slit portion 1038 allows the regularly-reflected-ray observation area 1095 to be reduced in size, making it possible to improve the spatial resolution. However, reducing the size of the slit of the regularly-reflected-ray slit portion 1038 would make it impossible for the regularly-reflected-ray photodiode 1039 to ensure the light quantity, resulting in a degradation of the S/N ratio. In order to satisfy the contradictory two conditions, the slit of the regularly-reflected-ray slit portion 1038 is desirably rectangular-shaped.

By making the slit of the regularly-reflected-ray slit portion 1038 rectangular-shaped, it becomes practicable to achieve a high spatial resolution in the sheet feed direction, and moreover to receive a proper quantity of light, allowing the measurement to be done with a high S/N ratio.

In the photodiodes 1036, 1039, an electric signal to be outputted varies due to temperature or other ambient environments, the signal is desirably normalized by some reference signal. That is, for fulfilment of accurate measurement of color information or positional information on the sheet 1032 based on electric signals outputted by the photodiodes 1036, 1039, as an example of the normalization, an upper-limit normalization reference signal and a lower-limit normalization reference signal are first determined.

That is, to digitize color information based on light-reception signals, fixed upper-limit reference signal and lower-limit reference signal are set beforehand as a part corresponding to a scale for the digitization. These upper-limit reference signal and lower-limit reference signal serve as absolute references.

In this embodiment, as an example, an electric signal outputted by the photodiodes 1036, 1039 upon reception of reflected light derived from a white portion of the sheet 1032 is assumed as the upper-limit reference signal, and an electric signal outputted by the photodiodes 1036, 1039 upon reception of reflected light from the casing 1041, which is a black portion, is assumed as the lower-limit reference signal.

This is because in the absence of the sheet 1032, the light flux emitted from the sheet information sensor is reflected by the casing 1041, the area on the casing 1041 should necessarily be black-colored. With the casing 1041 black-colored, in the presence of the sheet 1032, light emitted from the sheet information sensor is transmitted through by the sheet 1032, reflected by the casing 1041, and further transmitted again by the sheet 1032, so that stray light that comes incident on the sheet information sensor can be reduced in intensity. Thus, the measurement accuracy of the sheet information sensor can be improved.

Further, the lower-limit reference signal may be an electric signal which is outputted upon reception of reflected light derived from a black portion of the sheet 1032. Also, an output signal of the photodiodes 1036, 1039 without incidence of the reflected light from the sheet 1032 on the photodiodes 1036, 1039 may be used as the lower-limit reference signal.

Here is explained an example of measurement in which color information and positional information on the sheet 1032 are measured from outputs of the diffusely-reflected-ray photodiode 1036 and the regularly-reflected-ray photodiode 1039 resulting from measurement by the normalization method.

Referring first to the measurement of color information on the sheet 1032, color tone of the sheet 1032 is measured from outputs of the diffusely-reflected-ray photodiode 1036, and gloss of the sheet 1032 is measured from outputs of the regularly-reflected-ray photodiode 1039.

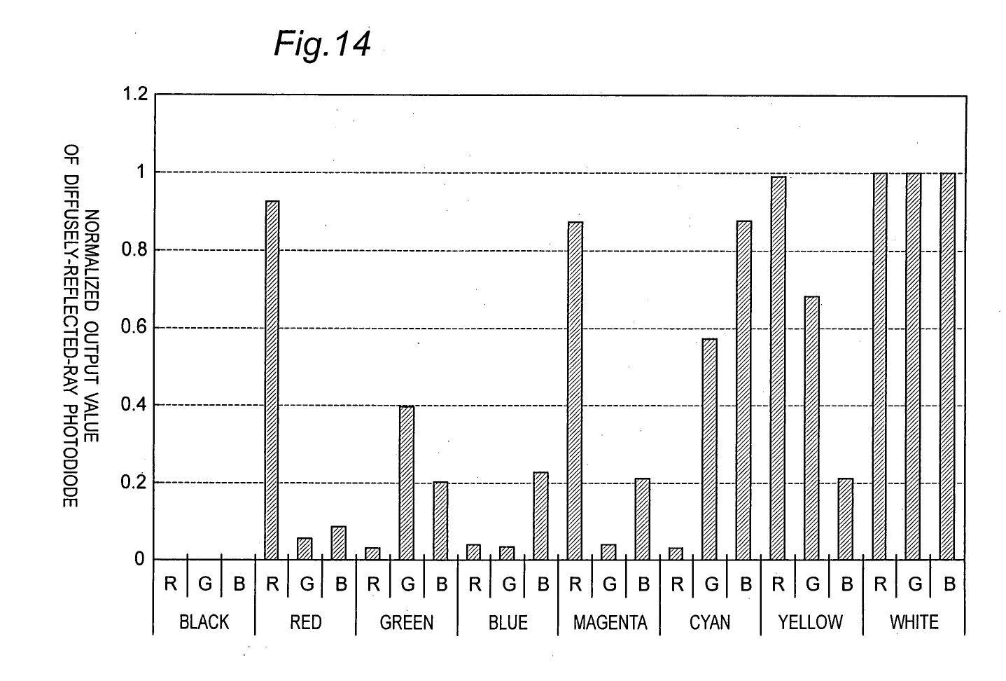

Individual items of ‘R’, ‘G’ and ‘B’ in the horizontal axis of FIG. 14 correspond to light-reception signals outputted by the diffusely-reflected-ray photodiode 1036 when light fluxes derived from the red, green and blue LEDs 1070, 1071, 1072 are reflected by the circular-shaped observation area 1094 on the sheet 1032 so as to be incident on the diffusely-reflected-ray photodiode 1036.

Also, individual fields of ‘BLACK’, ‘RED’, ‘GREEN’, ‘BLUE’, ‘MAGENTA’, ‘CYAN’, ‘YELLOW’ and ‘WHITE’ in the horizontal axis of FIG. 14 represent cases where the observation area 1094 of the sheet 1032 is black, red, green, blue, magenta, cyan, yellow and white, respectively. The vertical axis of FIG. 14 represents output values resulting from the normalization of the light-reception signals corresponding to the three-color reflected rays, respectively, by using the lower-limit reference signal, which is given by the light-reception signal derived from the black portion of the casing 1041, and the upper-limit reference signal, which is given by the light-reception signal derived from the white portion of the sheet 1032, as described before.

Items ‘R’, ‘G’ and ‘B’ in the field of ‘WHITE’ in the horizontal axis of FIG. 14 represent values resulting from the normalization of the light-reception signals of the photodiode 1036 that has received the three-color reflected rays derived from the white portion of the sheet 1032. In this embodiment, since the white portion of the sheet 1032 corresponds to the upper-limit reference signal, the individual normalized output values of ‘R’, ‘G’ and ‘B’ are each 1.

With respect to items ‘R’, ‘G’ and ‘B’ in the field of ‘BLACK’ in the horizontal axis of FIG. 14, since the black portion of the sheet 1032 is optically nearly equal to the black color of the casing 1041, which is the lower-limit reference signal, the individual normalized output values of ‘R’, ‘G’ and ‘B’ are each 0.

Items ‘R’, ‘G’ and ‘B’ in the field of ‘RED’ in the horizontal axis of FIG. 14 represent values resulting from the normalization of the light-reception signals of the photodiode 1036 that has received the three-color reflected rays derived from the red portion of the sheet 1032. When the observation area 1094 of the sheet 1032 is red-colored, there results a high signal output of the light-reception signal ‘R’ by the reflected ray originating from the light flux derived from the red light-emitting diode (LED-R) and reflected by the observation area 1094. Therefore, the normalized output value of the item ‘R’ in the field of ‘RED’ is close to 1, as compared with ‘G’ and ‘B’.

In the field of ‘GREEN’, where the observation area 1094 is green-colored, the normalized output value of the item ‘G’ is higher than those of the other items ‘R’ and ‘B’. Similarly, in the field of ‘BLUE’, where the observation area 1094 is blue-colored, the normalized output value of the item ‘B’ is higher than those of the normalized values of the other items ‘R’ and ‘G’.

Likewise, in the fields of ‘MAGENTA’, ‘CYAN’ and ‘YELLOW’ in the horizontal axis of FIG. 14, normalized output values of ‘R’, ‘G’ and ‘B’ in cases where the observation area 1094 of the sheet 1032 is magenta-, cyan- and yellow-colored, respectively, are shown. The same thing applies also to the case where the observation area 1094 is mixture-colored. For example, when the observation area 1094 of the sheet 1032 is magenta-colored (mixed color of red and blue), the normalized output value of the item ‘R’ and the normalized output value of the item ‘B’ become higher than the normalized output value of the item ‘G’.

In this way, the sheet information sensor outputs signals representing values resulting from the normalization, with the upper-limit reference signal and the lower-limit reference signal, of the light-reception signals corresponding to the three-color reflected rays, respectively, in proportion to red, green and blue color components of the observation area 1094 of the sheet 1032, and thus being enabled to decide the color tone of the sheet.

Further, the sheet information sensor is enabled to decide the gloss of the sheet 1032 by comparing outputs of the regularly-reflected-ray photodiode 1039 and the diffusely-reflected-ray photodiode 1036. That is, when the sheet 1032 is of high gloss, its regularly-reflected-ray component is larger in amount and its diffusely-reflected-ray component is smaller in amount, so that an output of the regularly-reflected-ray photodiode 1039 is larger and an output of the diffusely-reflected-ray photodiode 1036 is smaller. Conversely, when the sheet 1032 is of low gloss, its regularly-reflected-ray component is smaller in amount and its diffusely-reflected-ray component is larger in amount, so that an output of the regularly-reflected-ray photodiode 1039 is smaller and an output of the diffusely-reflected-ray photodiode 1036 is larger.

With the use of this sheet information sensor, by keeping management of the color information (including gloss) on the sheet 1032, it becomes possible to normally monitor the printing state of the printing device, thus making it possible to manage even changes in the printing state due to time changes of the printing device. Further, it is also possible to discriminate the sheet 1032 from the measurement of color tone and gloss of the sheet 1032.

Next, an example in which positional information on the sheet 1032 is measured from outputs of the regularly-reflected-ray photodiode 1039 is explained.

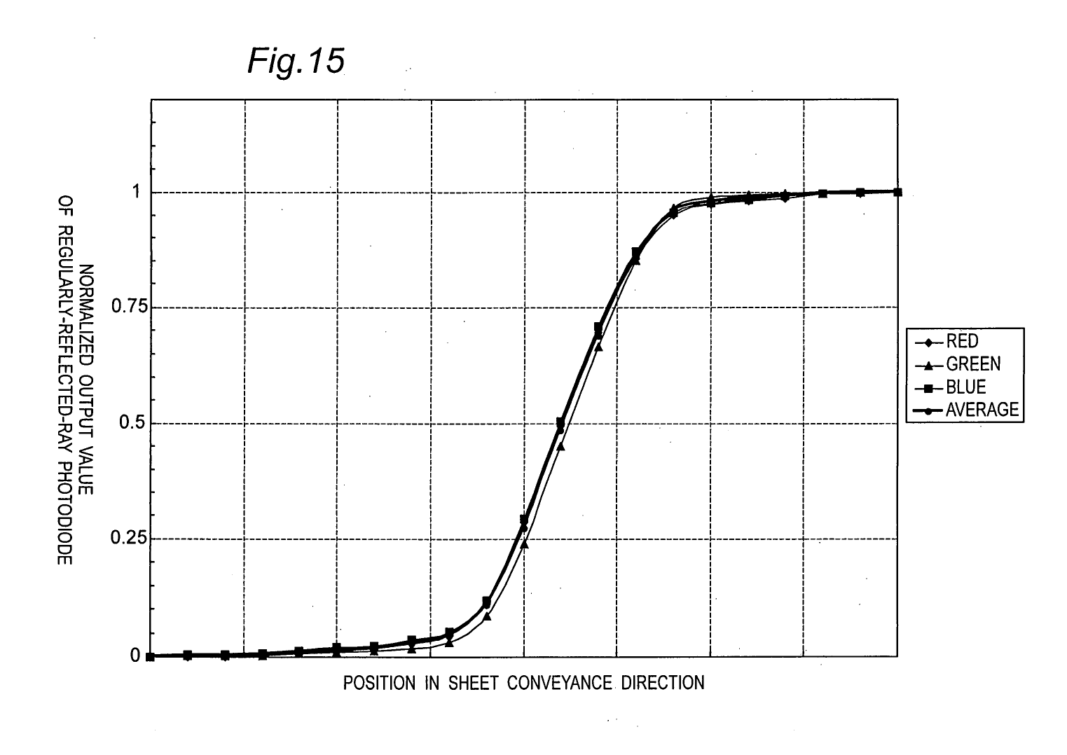

In the printing device, in which the sheet 1032 is fed one-dimensionally, if an edge of the sheet 1032 in the feed direction of the sheet 1032 can be detected, a position of the sheet 1032 can be specified. FIG. 15 shows a normalization result of outputs of the regularly-reflected-ray photodiode 1039 versus a position of the sheet 1032 performed by the foregoing normalization method when the sheet 1032 is fed.

Before the sheet 1032 is fed, the normalized output value of the regularly-reflected-ray photodiode 1039 in the vertical axis of FIG. 15 is 0. This means that in the absence of the sheet 1032, the regularly-reflected-ray photodiode 1039 receives reflected light from a black portion of the casing 1041. With this output assumed as the lower-limit reference signal in the above normalization method, the normalized output value of the regularly-reflected-ray photodiode 1039 is 0.

Then, starting in this state, the sheet 1032 is fed gradually on and on. As the sheet 1032 enters into the rectangular-shaped observation area 1095 of the regularly-reflected-ray photodiode 1039, the output begins to increase. When the observation area 1095 fully comes to the white portion on the sheet 1032, the normalized output value becomes 1 as shown in FIG. 15.

This is because, in this normalization method, the output of the regularly-reflected-ray photodiode 1039 resulting from reception of the reflected ray from the white portion of the sheet 1032 is assumed as the upper-limit reference signal. In these time changes of the sheet feed, normalized outputs of the regularly-reflected-ray photodiode 1039 versus sheet position are shown in FIG. 15.

In this connection, in FIG. 15, there are some differences among the intensities of reflected rays of R, G and B, which are derived from the sheet, relative to the sheet position, whereas equal outputs would be expected as a result of the normalization in terms of design. This is because the lens material has wavelength dispersion so that the lens material slightly differs in refractive index among the individual R, G and B colors. Thus, strictly, the observation area 1095 on the sheet 1032 for the regularly-reflected-ray photodiode 1039 slightly varies among the individual R, G and B colors. To solve this problem, there is a need for using not a single lens but a plurality of combinational lenses (achromatic lenses). However, this would cause an increase in cost, impractically.

In this embodiment, as shown in FIG. 15, to correct slight differences among the reflected rays of the individual R, G and B colors, normalized output values of the regularly-reflected-ray photodiode 1039 are averaged among the R, G and B colors, and a position of the sheet 1032 is detected by using the resulting average signal. Referring to FIG. 15, out of normalized output values of the regularly-reflected-ray photodiode 1039, when the average output of the R, G and B colors becomes 0.5 (=(upper-limit reference signal+lower-limit reference signal)/2), it can be said that the observation area 1095 contains a white-colored area from the sheet 1032 in one half and a black-colored area from the casing 1041 in the other half. That is, it can be said that when the normalized output value becomes 0.5, an edge of the sheet 1032 is present on a line segment 1096 that divides the observation area 1095 into two portions in the sheet conveyance direction as viewed in FIG. 12. This means that the line segment 1096 serves as a sheet detection position in the sheet conveyance direction. In this way, positional information on the sheet 1032 can be measured from normalized output values of the regularly-reflected-ray photodiode 1039.

According to this sheet information sensor, an image can be formed at an assumed position by detecting positional information on the sheet 1032 with high efficiency. For frameless printing, also, by virtue of the capability of high-efficiency control over the positional information, it never occurs that overflowing ink out of the sheet 1032 stains the casing 1041. Accordingly, it never occurs that a sheet that passes through the same place thereafter is stained.

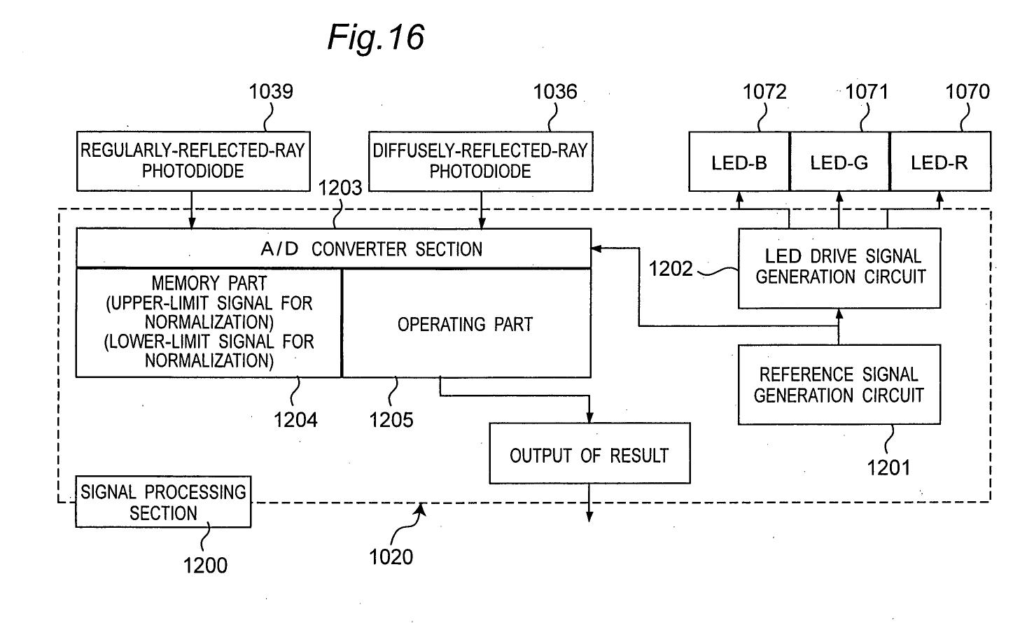

As shown in FIG. 16, the calculation section 1020 includes a signal processing part 1200 for normalizing electric signals outputted by the diffusely-reflected-ray photodiode 1036 with reference signals and for normalizing electric signals outputted by the regularly-reflected-ray photodiode 1039 with reference signals.

The signal processing part 1200 has an A/D converter section 1203 for converting outputs of the diffusely-reflected-ray photodiode 1036 and the regularly-reflected-ray photodiode 1039 into digital signals, a memory part 1204 for storing therein a normalization upper-limit signal and a normalization lower-limit signal for the normalization method, and an operating part 1205 for processing signals according to the normalization method to output a calculation result to the print side.

Also, the signal processing part 1200 has a reference signal generation circuit 1201 for generating a reference signal, and an LED drive signal generation circuit 1202 for generating, based on the reference signal, drive signals for the red light-emitting diode 1070, green light-emitting diode 1071 and blue light-emitting diode 1072, respectively.

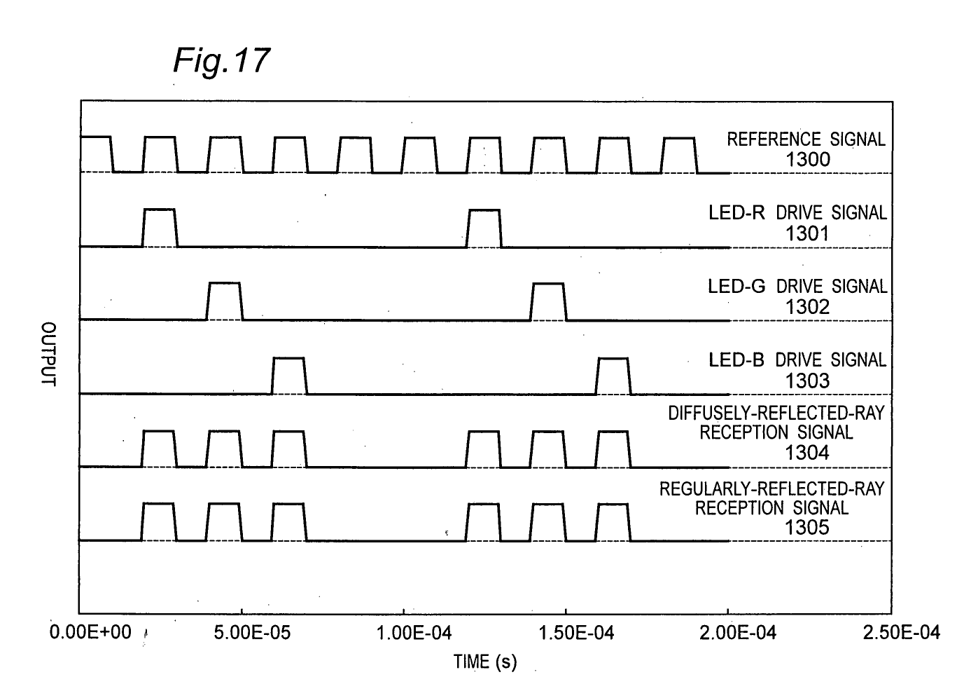

In the calculation section 1020, the timing of light emission is controlled by the time-division light reception and emission method, by which signal interference of the R, G and B signals on the light-reception side is prevented. FIG. 17 shows an example of the timing chart of the light emission and reception timing.

First, a reference signal 1300 having a pulse waveform of a specified period outputted by the reference signal generation circuit 1201 is taken as a reference, the reference signal 1300 serving as a reference for all signals. A signal delayed by a specified time from the reference signal 1300 is set as a LED-R drive signal to be inputted to the red light-emitting diode 1070. Similarly, a LED-G drive signal 1302 to be inputted to the green light-emitting diode 1071 as well as a LED-B drive signal 1303 to be inputted to the blue light-emitting diode 1072 are signals delayed by a specified time from the reference signal 1300.

In this connection, importance lies not in the order of light emission but in that the timing of light emission for the individual colors does not overlap with each other. Thus, by preventing the timing of light emission for the individual colors from overlapping with one another, it becomes possible to prevent interference among light-reception signals of the individual colors also on the light-reception side, so that the measurement accuracy can be improved.

Examples of reception signals of the diffusely-reflected-ray photodiode 1036 and the regularly-reflected-ray photodiode 1039 in such a light emission method as shown above are a diffusely-reflected-ray reception signal 1304 and a regularly-reflected-ray reception signal 1305, respectively. In this connection, for the reception signals 1304, 1305, it is important that reflected rays of the individual R, G and B colors are time divided so as not to influence one another, as shown in FIG. 17.

Therefore, the LED drive signals 1301, 1302, 1303 are modulated in intensity. Desirably, the LED drive signals 1301, 1302, 1303 are driven in pulses at a duty ratio of 0.1 or less, as an example.

Thus, in the photodiodes 1036, 1039, interference among the individual colors of light-reception signals can be prevented. Also for the LEDs 1070, 1071, 1072, by decreasing the duty by the pulse drive method, it becomes possible to obtain emission power of larger light quantities with the average current consumption unchanged, as compared with the DC (Direct Current) drive method.

In other words, when a certain quantity of light is emitted by the pulse drive method and the DC drive method, the pulse drive method results in smaller average current consumption, hence economical. Further, the pulse drive method is superior in the life of LEDs as well as in heat radiation over the DC drive method, and so the output is stabilized.

In addition, the calculation section 1020 may be part of a printing device. That is, it is also possible that analog signals are outputted from the diffusely-reflected-ray photodiode 1036 and the regularly-reflected-ray photodiode 1039 to the printing device side, where the signal processing is performed by using the memory or the operating section on the printing device side.

In addition, in this embodiment, the light-emitting part 1030 includes the red LED 1070, the green LED 1071 and the blue LED 1072. However, the LEDs to be included in the light-emitting part 1030 may be two or four or more LEDs for generating light of mutually different colors other than red, green and blue.

Furthermore, the light-emitting part 1030 may include a plurality of laser diodes of different emission wavelengths. Also, although photodiodes are adopted as the light-receiving part in this embodiment, it is also possible to adopt other light-receiving elements such as phototransistors and photo ICs.

Also, the diffusely-reflected-ray photodiode 1036 and the regularly-reflected-ray photodiode 1039 may be formed on one identical board, where a smaller-sized print object information measuring device (sheet information sensor) can be provided.

### Fifth Embodiment

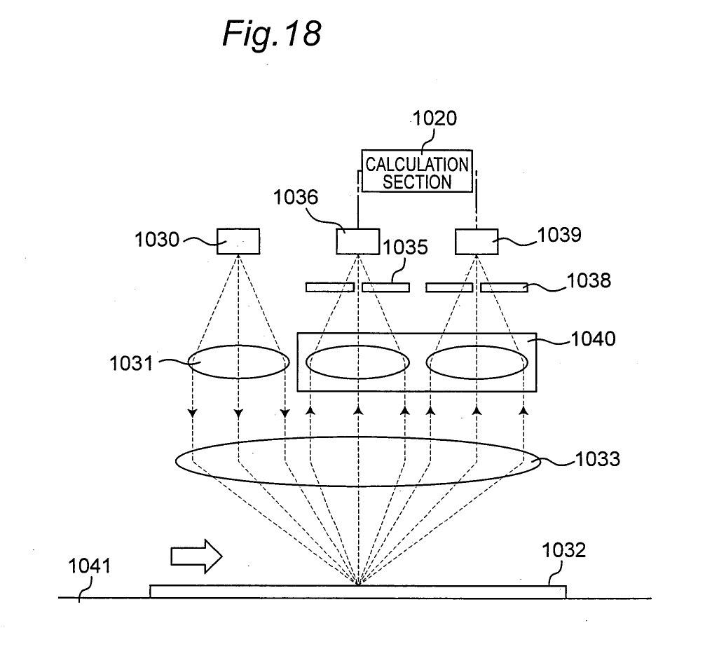

FIG. 18 shows a fifth embodiment of the print object information measuring device of the invention. This fifth embodiment differs from the foregoing fourth embodiment (FIG. 10) in that the diffusely-reflected-ray condenser lens 1034 and the regularly-reflected-ray condenser lens 1037 of FIG. 10 are provided by one integrated lens 1040 in this fifth embodiment. It is noted that the same component elements as those of FIG. 10 are designated by the same reference numerals and their description is omitted.

In the print object information measuring device of this constitution, since the diffusely-reflected-ray condenser lens 1034 and the regularly-reflected-ray condenser lens 1037 are provided by one lens, parts count of the optical system can be reduced, so that a low-priced print object information measuring device (sheet information sensor) which involves less man-hours in its manufacturing process can be realized.

### Sixth Embodiment

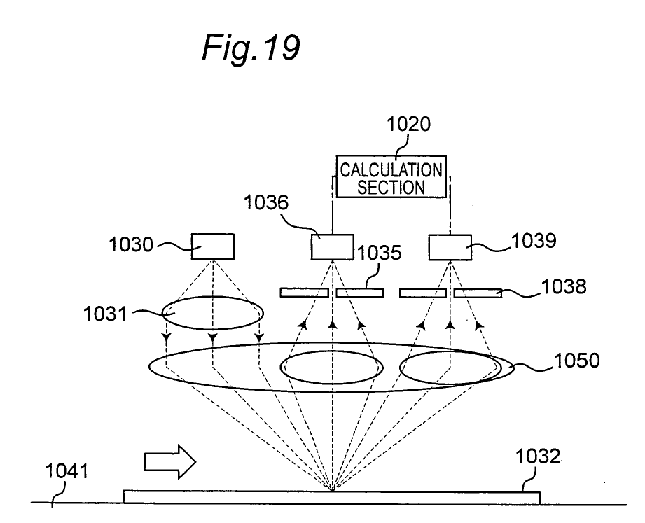

FIG. 19 shows a sixth embodiment of the print object information measuring device of the invention. This sixth embodiment differs from the foregoing fourth embodiment (FIG. 10) in that the diffusely-reflected-ray condenser lens 1034, the regularly-reflected-ray condenser lens 1037 and the objective condenser lens 1033 of FIG. 10 are provided by one integrated lens 1050 in this sixth embodiment. It is noted that the same component elements as those of FIG. 10 are designated by the same reference numerals and their description is omitted.

In the print object information measuring device of this constitution, since the diffusely-reflected-ray condenser lens 1034, the regularly-reflected-ray condenser lens 1037 and the objective condenser lens 1033 are provided by one lens, parts count of the optical system can be reduced, so that a smaller-sized, low-priced print object information measuring device (sheet information sensor) which involves less man-hours in its manufacturing process can be realized.

### Seventh Embodiment

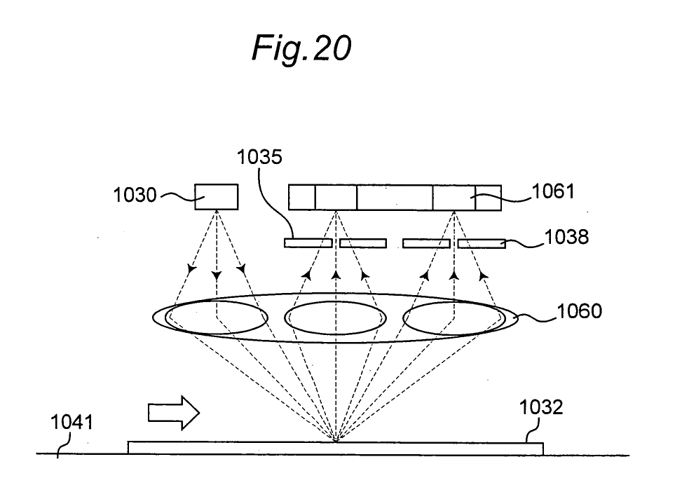

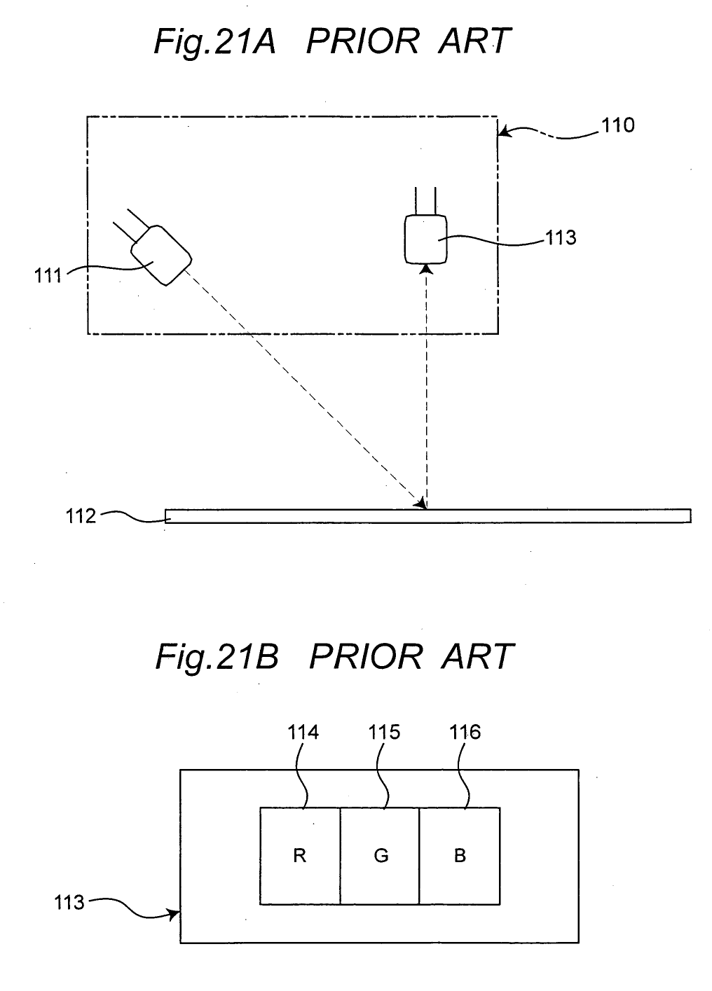

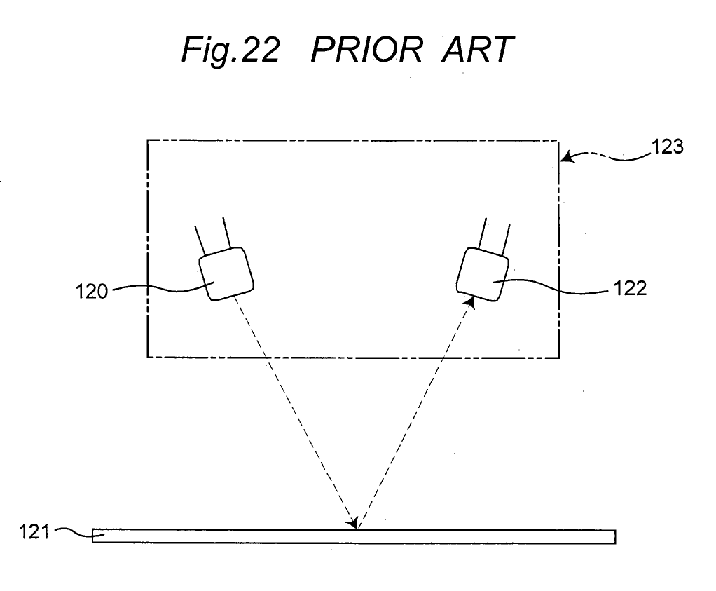

FIG. 20 shows a seventh embodiment of the print object information measuring device of the invention. This seventh embodiment differs from the foregoing fourth embodiment (FIG. 10) in that the light-emitting condenser lens 1031, the diffusely-reflected-ray condenser lens 1034, the regularly-reflected-ray condenser lens 1037 and the objective condenser lens 1033 of FIG. 10 are provided by one integrated lens 1060 in this seventh embodiment. It is noted that the same component elements as those of FIG. 10 are designated by the same reference numerals and their description is omitted.

In the print object information measuring device of this constitution, since the light-emitting condenser lens 1031, the diffusely-reflected-ray condenser lens 1034, the regularly-reflected-ray condenser lens 1037 and the objective condenser lens 1033 are provided by one lens, parts count of the optical system can be reduced, so that a smaller-sized, low-priced print object information measuring device (sheet information sensor) which involves less man-hours in its manufacturing process can be realized.

Further, the diffusely-reflected-ray receiving part and the regularly-reflected-ray receiving part are provided by a divisional photodiode 1061. Accordingly, since the man-hours in the manufacturing process can be reduced, a cost reduction can be allowed. Moreover, since a small-sized optical system can be made up more by the divisional photodiode, a small-sized, low-priced sheet information sensor can be provided.

Furthermore, the integrated lens 1060 may be replaced with a Fresnel lens. It is noted here that the term “Fresnel lens” refers to a lens which is reduced in a wall thickness of its portion through which light inside the lens travels straight so that its thickness can be reduced as compared with ordinary spherical lenses. By adopting a Fresnel lens, a short-focal-length, bright lens which is thinner in thickness and smaller in F value than ordinary spherical lenses can be realized. Thus, a Fresnel lens is preferably used because successful optical characteristics can be obtained.

Furthermore, the light-emitting condenser lens 1031, the diffusely-reflected-ray condenser lens 1034, the regularly-reflected-ray condenser lens 1037 and the objective condenser lens 1033 of the fourth embodiment, or the integrated lens 1040 of the fifth embodiment, or the integrated lens 1050 of the sixth embodiment may be provided by a Fresnel lens.

Further, the printing device of the invention, based on color information and positional information on the sheet 1032 as a print object measured by the sheet information sensor according to any one of the foregoing fourth to seventh embodiments, controls color and position of sheets that are to be printed thereafter.

Thus, according to the printing device of the invention, based on color information and positional information on the sheet 1032 measured by the sheet information sensor, color and position of the sheet 1032 that are to be printed thereafter are controlled, high-precision printing can be achieved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A color information measuring device comprising:
a light-emitting part having a plurality of light-emitting elements which differ in emission wavelength from one another;
an illuminating part for illuminating an measurement object, which is to be measured, with a plurality of light fluxes of different wavelengths derived from the light-emitting part;
a light-receiving element for converting a plurality of received light fluxes of different wavelengths into electric signals, respectively, as their outputs; and
a condenser part for condensing reflected rays derived from the measurement object onto the light-receiving element, wherein
the plurality of light fluxes of mutually different wavelengths applied from the light-emitting elements to the measurement object have a common illumination area on the measurement object, and
the common illumination area on the measurement object contains an observation area on their measurement object from which reflected rays go incident on the light-receiving element via the condenser part.

2. The color information measuring device as claimed in claim 1, wherein
the light-emitting part has three light-emitting elements which differ in emission wavelength from one another.

3. The color information measuring device as claimed in claim 2, wherein
the three light-emitting elements have emission wavelengths corresponding to red, green and blue, respectively.

4. The color information measuring device as claimed in claim 1, further comprising
a slit member placed between the condenser part and the light-receiving element, wherein
the slit member has a circular-shaped slit, and
the observation area on the measurement object is circular-shaped.

5. The color information measuring device as claimed in claim 4, wherein
the observation area on the measurement object is smaller than a circle having a diameter of 2 mm.

6. The color information measuring device as claimed in claim 2, wherein
the three light-emitting elements of the light-emitting part are formed on one board.

7. The color information measuring device as claimed in claim 2, wherein
the three light-emitting elements of the light-emitting part include a light-emitting-element drive part for emitting light sequentially in time division.

8. The color information measuring device as claimed in claim 7, wherein
the light-receiving element is a photodiode.

9. The color information measuring device as claimed in claim 2, further comprising:
a wavelength selector part placed between the condenser part and the light-receiving element, and
a light-emitting-element drive part for making the three light-emitting elements of the light-emitting part emit light simultaneously.

10. The color information measuring device as claimed in claim 9, wherein
the wavelength selector part is a diffraction grating.

11. The color information measuring device as claimed in claim 9, wherein
the light-receiving element is a divisional photodiode having a plurality of independent light-receiving portions.

12. The color information measuring device as claimed in claim 11, wherein
spot size of each of the light fluxes condensed at the light-receiving portions of the divisional photodiode by the condenser part is smaller than an area of its corresponding light-receiving portion.

13. The color information measuring device as claimed in claim 1, wherein
the illuminating part is a lens.

14. The color information measuring device as claimed in claim 1, wherein
the condenser part is a lens.

15. The color information measuring device as claimed in claim 1, wherein
one lens serves as both the illuminating part and the condenser part.

16. The color information measuring device as claimed in claim 13, wherein
the lens is a Fresnel lens.

17. The color information measuring device as claimed in claim 1, further comprising:
a signal processing part for normalizing an electric signal outputted by the light-receiving element with a reference signal.

18. The color information measuring device as claimed in claim 17, wherein
the signal processing part normalizes an electric signal outputted by the light-receiving element by using an upper-limit reference signal and a lower-limit reference signal.

19. The color information measuring device as claimed in claim 18, wherein
the upper-limit reference signal is an electric signal which is outputted by the light-receiving element upon reception of a reflected ray derived from a white portion, and
the lower-limit reference signal is an electric signal which is outputted by the light-receiving element upon reception of a reflected ray derived from a black portion.

20. The color information measuring device as claimed in claim 1, wherein
the light-emitting elements are light-emitting diodes.

21. The color information measuring device as claimed in claim 1, further comprising
a pulse drive part for driving the light-emitting elements in pulses.

22. The color information measuring device as claimed in claim 21, wherein
the pulse drive part drives the light-emitting elements in pulses at a duty ratio of 0.1 or less.

23. Electronic equipment including the color information measuring device as claimed in claim 1.

24. The electronic equipment as claimed in claim 23, wherein
the electronic equipment is functionally controlled by electric signals outputted by the color information measuring device.

25. A print object information measuring device comprising:
a light-emitting part for emitting a plurality of light fluxes which differ in emission wavelength from one another;
a light-emitting-part side condenser part for converting each light flux derived from the light-emitting part into collimated light of substantially parallel state;
an objective-side condenser part for applying the collimated light derived from the light-emitting-part side condenser part onto a print object and further converting a diffusely reflected ray and a regularly reflected ray derived from the print object into collimated light of substantially parallel state, respectively;
a diffusely-reflected-ray receiving part for converting the diffusely reflected ray derived from the print object into an electric signal;
a regularly-reflected-ray receiving part for converting the regularly reflected ray derived from the print object into an electric signal;
a diffusely-reflected-ray condenser part which is positioned between the objective-side condenser part and the diffusely-reflected-ray receiving part and which condenses the collimated light derived from the objective-side condenser part onto the diffusely-reflected-ray receiving part;
a regularly-reflected-ray condenser part which is positioned between the objective-side condenser part and the regularly-reflected-ray receiving part and which condenses the collimated light derived from the objective-side condenser part onto the regularly-reflected-ray receiving part; and
a calculation part for calculating color information on the print object by an output derived from at least either the diffusely-reflected-ray receiving part or the regularly-reflected-ray receiving part and moreover calculating positional information on the print object by an output derived from the regularly-reflected-ray receiving part.

26. The print object information measuring device as claimed in claim 25, wherein
the light-emitting part has three light-emitting elements which differ in emission wavelength from one another.

27. The print object information measuring device as claimed in claim 26, wherein
the three light-emitting elements have emission wavelengths corresponding to red, green and blue, respectively.

28. The print object information measuring device as claimed in claim 25, further comprising:
a diffusely-reflected-ray slit portion placed between the diffusely-reflected-ray condenser part and the diffusely-reflected-ray receiving part and having a slit, wherein
the plurality of light fluxes applied from the light-emitting part onto the print object form a common illumination area on the print object, and
the illumination area contains such a diffusely-reflected-ray observation area that the diffusely reflected ray is made to be incident on the diffusely-reflected-ray receiving part via the objective-side condenser part, the diffusely-reflected-ray condenser part and the slit of the diffusely-reflected-ray slit portion.

29. The print object information measuring device as claimed in claim 28, wherein
the slit of the diffusely-reflected-ray slit portion is circular-shaped.

30. The print object information measuring device as claimed in claim 25, further comprising
a regularly-reflected-ray slit portion placed between the regularly-reflected-ray condenser part and the regularly-reflected-ray receiving part and having a slit, wherein
the plurality of light fluxes applied from the light-emitting part to the print object have a common illumination area on the print object, and
the illumination area contains such a regularly-reflected-ray observation area that the regularly reflected ray is made to be incident on the regularly-reflected-ray receiving part via the objective-side condenser part, the regularly-reflected-ray condenser part and the slit of the regularly-reflected-ray slit portion.

31. The print object information measuring device as claimed in claim 30, wherein
the slit of the regularly-reflected-ray slit portion is rectangular-shaped.

32. The print object information measuring device as claimed in claim 25, wherein
the light-emitting-part side condenser part is a lens.

33. The print object information measuring device as claimed in claim 25, wherein
the diffusely-reflected-ray condenser part is a lens.

34. The print object information measuring device as claimed in claim 25, wherein
the regularly-reflected-ray condenser part is a lens.

35. The print object information measuring device as claimed in claim 25, wherein
the objective-side condenser part is a lens.

36. The print object information measuring device as claimed in claim 25, wherein
the diffusely-reflected-ray condenser part and the regularly-reflected-ray condenser part are provided by one lens.

37. The print object information measuring device as claimed in claim 25, wherein
the diffusely-reflected-ray condenser part, the regularly-reflected-ray condenser part and the objective-side condenser part are provided by one lens.

38. The print object information measuring device as claimed in claim 25, wherein
the light-emitting-part side condenser part, the diffusely-reflected-ray condenser part, the regularly-reflected-ray condenser part and the objective-side condenser part are provided by one lens.

39. The print object information measuring device as claimed in claim 32, wherein
the lens is a Fresnel lens.

40. The print object information measuring device as claimed in claim 26, wherein
the three light-emitting elements are mounted on one identical board.

41. The print object information measuring device as claimed in claim 25, wherein
a signal for driving the light-emitting part therewith is modulated in intensity.

42. The print object information measuring device as claimed in claim 41, wherein
a signal for driving the light-emitting part therewith is a rectangular wave, and
the rectangular wave has a duty ratio of 0.1 or less.

43. The print object information measuring device as claimed in claim 41, wherein
the light-emitting part emits the plurality of light fluxes in time division.

44. The print object information measuring device as claimed in claim 25, wherein
the light-emitting part is provided by light-emitting diodes.

45. The print object information measuring device as claimed in claim 25, wherein
the diffusely-reflected-ray receiving part and the regularly-reflected-ray receiving part are photodiodes.

46. The print object information measuring device as claimed in claim 45, wherein
the photodiodes of the diffusely-reflected-ray receiving part and the regularly-reflected-ray receiving part are formed on one identical board.

47. The print object information measuring device as claimed in claim 25, wherein
the diffusely-reflected-ray receiving part and the regularly-reflected-ray receiving part are provided by a divisional photodiode.

48. The print object information measuring device as claimed in claim 25, wherein
the calculation part includes a signal processing part for normalizing an electric signal outputted by the diffusely-reflected-ray receiving part by using a reference signal.

49. The print object information measuring device as claimed in claim 25, wherein
the calculation part includes a signal processing part for normalizing an electric signal outputted by the regularly-reflected-ray receiving part by using a reference signal.

50. The print object information measuring device as claimed in claim 48, wherein
the signal processing part normalizes an electric signal outputted by the diffusely-reflected-ray receiving part by using an upper-limit reference signal and a lower-limit reference signal.

51. The print object information measuring device as claimed in claim 49, wherein
the signal processing part normalizes an electric signal outputted by the regularly-reflected-ray receiving part by using an upper-limit reference signal and a lower-limit reference signal.

52. The print object information measuring device as claimed in claim 50, wherein
the upper-limit reference signal is an electric signal which is outputted by the diffusely-reflected-ray receiving part upon its reception of a diffusely reflected ray from a white portion, and
the lower-limit reference signal is an electric signal which is outputted by the diffusely-reflected-ray receiving part upon its reception of a diffusely reflected ray from a black portion.

53. The print object information measuring device as claimed in claim 51, wherein
the upper-limit reference signal is an electric signal which is outputted by the regularly-reflected-ray receiving part upon its reception of a regularly reflected ray from a white portion, and
the lower-limit reference signal is an electric signal which is outputted by the regularly-reflected-ray receiving part upon its reception of a regularly reflected ray from a black portion.

54. The print object information measuring device as claimed in claim 51, wherein
the calculation part calculates, as positional information on the print object, a position of the print object resulting when an average value of individual wavelengths of normalized outputs of the regularly-reflected-ray receiving part becomes (upper-limit reference signal+lower-limit reference signal)/2.

55. A printing device which, based on color information and positional information on the print object measured by the print object information measuring device as defined in claim 25, controls color and position of print objects that are to be printed thereafter.
